(19) United States
(12) Patent Application Publication
(10) Pub. No.: US 2002/0182955 A1
(43) Pub. Date: Dec. 5, 2002

(54) Structural bonding tapes and articles containing the same

(76) Inventors: James T. Weglewski, St. Paul, MN (US); Dennis C. Ngo, St. Paul, MN (US)

Correspondence Address: Office of Intellectual Property Counsel, 3M Innovative Properties Company, P.O. Box 33427, St. Paul, MN, 55133-3427, US

(21) Appl. No.: 09/823,189

(22) Filed: Mar. 29, 2001

(51) Int. Cl. B32B 3/00

(52) U.S. Cl. 442/59

(57) ABSTRACT

The present invention is directed to structural bonding tapes and methods of making such tapes. The present invention further directed to articles of manufacture containing one or more components bonded together with structural bonding tape.

### FIELD OF THE INVENTION

The present invention relates to structural bonding tapes and methods of making such tapes. The present invention further relates to articles of manufacture containing one or more components bonded together with structural bonding tape.

### BACKGROUND OF THE INVENTION

Structural bonding tapes are useful for bonding one or more substrates to one another. Typically, a length of structural bonding tape or a die cut piece of tape is removed from a roll, and attached to a first substrate using finger pressure. Then, a second substrate is brought into contact with the exposed surface of the structural bonding tape, heat and pressure is applied to the substrates for a period of time, and then the bonded substrate is allowed to cool. The result is a bonded article.

Many structural bonding tapes fall into one of two groups: (1) heat-curable structural bonding tapes, and (2) ultraviolet (UV) light-activatable structural bonding tapes or ultraviolet light cure-initiatable (UVi) structural bonding tapes. As suggested by the class name, heat-curable structural bonding tapes require heat to cure the adhesive composition of the tape. The UVi structural bonding tapes contain an adhesive composition that will begin to cure when exposed to UV light, but does not require heat for curing. Heat may be used to accelerate the rate of cure for Ui structural bonding tapes.

Many adhesive composition formulations of conventional UVi structural bonding tapes lead to shortcomings in the handling characteristics and performance of the tape. These shortcomings include material softness and flowability, which result in handling problems such as unacceptable stretching and/or tearing when being removed from a tape roll or when a release liner is removed from one or more surfaces of the tape. Further, many adhesive composition formulations of conventional UVi structural bonding tapes are so soft and stretchy that the formulations cannot be die cut without first chilling the tape material. Even after chilling, the tape formulation may not have enough cohesive body to allow “weed removal” during die cutting. As used herein, the term “weed removal” refers to the process of removing excess tape material from a die cut piece of tape. The difficulty in weed removal encountered using conventional Uvi structural tape formulations is especially pronounced at tape thicknesses above 10 mils. Typically, at tape thicknesses above 10 mils, conventional UVi tape formulations have to be chilled prior to die cutting in order to minimize the problems with weed removal.

Further, conventional Uvi structural bonding tape formulations possess high cold flow properties. Cold flow is a measure of the creep behavior of a material at non-elevated temperatures. Many conventional UVi tape materials possess undesirably high cold flow properties, which result in significant material flow under roll winding tensions and stacking weight. As a result, these materials require cold storage and/or special packaging to maintain dimensionally stable rolls and die cut parts.

In addition, many adhesive composition formulations of conventional structural bonding tapes require heat to cure the adhesive composition. In a process of making bonded articles, the bonded article must be subjected to a heating step in order to cure the adhesive composition, as well as, a cooling step in order to allow for further handling and/or packaging of the bonded article. From a processing standpoint, a process of making bonded articles without a heating step would be highly desirable.

What is needed in the art is a structural bonding tape, which possesses exceptional cold flow properties and handleability so that the tape does not require special packaging or cold storage. What is also needed in the art is a structural bonding tape formed from an adhesive composition formulation, which does not require heat in order to cure the adhesive composition. In addition, what is needed in the art is a UVi structural bonding tape having a tape construction, which allows the tape to be light-activatable from one side of the tape.

### SUMMARY OF THE INVENTION

The present invention addresses some of the difficulties and problems discussed above by the discovery of a novel structural bonding tape having improved cold flow properties, as well as, exceptional adhesion properties. The structural bonding tape possesses desired strength and adhesion properties, which are the result of combining a fiber reinforcement and an adhesive composition. The structural bonding tape may be light-activated (i.e., cure is initiated upon exposure to a light source) by exposing the tape to a light source on one side of the tape. Further, the structural bonding tape does not require heat for curing. The structural bonding tape may be used in a number of applications, in particular, as an adhesive for bonding together one or more substrates.

The present invention is further directed to a method ofmaking the structural bonding tape. In one embodiment of the present invention, the structural bonding tape is prepared by at least partially embedding a fiber reinforcement in an adhesive composition. The method of making the structural bonding tape may include fully encapsulating the fiber reinforcement in the adhesive composition.

The present invention is even further directed to articles of manufacture comprising two or more similar or different substrates bonded to one another by one or more structural bonding tapes. In one embodiment of the present invention, the article of manufacture comprises an abraded metal substrate bonded to a second substrate using a structural bonding tape.

The present invention is even further directed to a method of making a bonded article comprising the structural bonding tape bonded to at least one substrate. In one embodiment of the present invention, the method comprises bonding two or more similar or different substrates to one another by one or more structural bonding tapes, wherein the adhesive composition of the one or more structural bonding tapes is activated by actinic radiation.

These and other features and advantages of the present invention will become apparent after a review of the following detailed description of the disclosed embodiments and the appended claims.

### BRIEF DESCRIPTION OF THE DRAWINGS

The present invention is further described with reference to the appended figures, wherein:

FIG. 1 is a cross-sectional view of an exemplary structural bonding tape of the present invention;

FIG. 2 is a cross-sectional view of an exemplary structural bonding tape of the present invention in a roll configuration;

FIG. 3 is a schematic diagram of an exemplary process for making the structural bonding tape of the present invention;

FIG. 4 is a schematic diagram of an exemplary process for making the structural bonding tape of the present invention;

FIG. 5 is a schematic diagram of an exemplary process for making the structural bonding tape of the present invention;

FIG. 6 is a cross-sectional view of a first substrate bonded to a second substrate via a structural bonding tape of the present invention; and

FIG. 7 is a schematic diagram of an exemplary process for making a bonded article of the present invention.

### DETAILED DESCRIPTION OF THE INVENTION

The present invention is directed to a novel structural bonding tape having improved cold flow properties and handleability, as well as, exceptional adhesion properties. The structural bonding tape comprises at least one fiber reinforcement and at least one structural adhesive composition. The components of the structural bonding tape are selected and assembled in such a way that the resulting tape has (1) desirable cold flow and handling properties, (2)is activated (i.e., curing is initiated) by exposure to actinic radiation, (3) does not require heat for curing, and (4) when cured, has exceptional adhesion properties. The present invention is also directed to a method of making the structural bonding tape and articles of manufacture comprising the structural bonding tape.

It has been discovered that fiber reinforcements having particular properties may be incorporated into an adhesive composition to form structural bonding tapes of the present invention having desirable pre-cured and post-cured properties. Suitable fiber reinforcements have a desired porosity, basis weight, thickness, drapeability, fiber composition, fiber diameter, or combination of two or more of these properties. As used herein, the term “porosity” is used to describe one or more properties of the fiber reinforcement: air permeability, light permeability, adhesive composition permeability (i.e., the ability of the adhesive composition to infiltrate the fiber reinforcement). Incorporation of the fiber reinforcements into the adhesive composition does not negatively impact the ability of the composition to be activated by actinic radiation. As used herein, the terms “activate”, “activated”, and “activatable” are used to describe the initiation of the curing process of an adhesive composition. Incorporation of one or more fiber reinforcements into the adhesive composition does not require an additional amount of actinic radiation in order to activate the resulting structural bonding tapes of the present invention. In addition, the structural bonding tape may be activated by exposing either side of the structural bonding tape to actinic radiation. In other words, exposure to actinic radiation on both sides of the tape is unnecessary even though one or more fiber reinforcement is present within the adhesive composition of the structural bonding tape. Further, incorporation of one or more fiber reinforcements into the adhesive composition limits undesirable stretchiness and cold flow of the tape, but permits beneficial gap filling, die cuttability, and surface wetting properties of the adhesive composition.

Structural Bonding Tape Materials

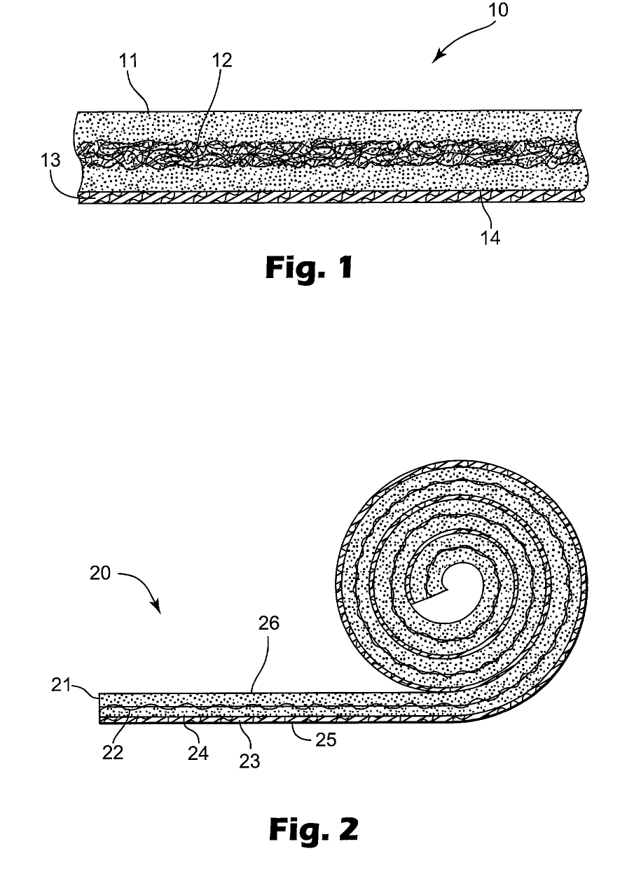

The structural bonding tapes of the present invention may comprise one or more fiber reinforcements in combination with one or more adhesive compositions. Desirably, the structural bonding tapes of the present invention comprise a single fiber reinforcement in combination with a single layer of adhesive composition to form a structural adhesive layer. The structural adhesive layer may be used alone or in combination with other layers including, but not limited to, additional structural adhesive layers; one or more non-structural (i.e., does not contain a fibrous web) adhesive layers (e.g., pressure-sensitive adhesive layers); one or more non-adhesive film, foil, foam, paper, or fabric layers; and one or more release liners. An exemplary structural bonding tape of the present invention is shown in FIG. 1. As shown in FIG. 1, the exemplary structural bonding tape 10 comprises a structural adhesive layer 11 containing a fiber reinforcement 12, and a release liner 13 on an outer surface 14 of structural adhesive layer 11.

A variety of materials may be used to form the structural bonding tape of the present invention. A description of materials suitable for use in the present invention is given below.

I. Structural Adhesive Layer Materials

The following materials may be used to form the structural adhesive layer of the structural bonding tape of the present invention.

A. Fiber Reinforcement Materials

The structural adhesive layer of the structural bonding tape of the present invention may comprise one or more fiber reinforcements. The one or more fiber reinforcements, each taken independently or together, possess an amount of porosity and a thickness, which enables the structural adhesive layer of the structural bonding tape to be activated by actinic radiation and fully cured without heat. As used herein, the term “actinic radiation” is used to describe radiation having a spectrum in the ultraviolet (UV) or visible (VIS) spectral regions with a wavelength of from about 200 nm to about 700 nm. Further, the one or more fiber reinforcements, each taken independently or together, possess an overall basis weight, which enables the production of a structural adhesive layer having improved cold flow properties, reduced stretchability, and enhanced tape strength. In addition, the one or more fiber reinforcements comprise fibrous webs containing fibers having fiber characteristics, such as fiber diameter and fiber composition, which enables a desirable distribution of individual fibers within the adhesive composition such that a minimal amount of actinic radiation is required to activate the composition.

The one or more fiber reinforcements suitable for use in the present invention may comprise one or more fiber-containing webs including, but not limited to, woven fabrics, nonwoven fabrics, knitted fabrics, and a unidirectional array of fibers. Desirably, the one or more fiber reinforcements comprise a nonwoven fabric, such as a scrim. Materials for making the one or more fiber reinforcements for use in the present invention may comprise any fiber-forming material capable of being formed into one of the above-described webs. Suitable fiber-forming materials include, but are not limited to, polymeric materials such as polyesters, polyolefins, and aramids; organic materials such as wood pulp and cotton; inorganic materials such as glass, carbon, and ceramic; coated fibers having a core component (i.e., any of the above fibers) and a coating thereon, wherein the coating provides a desirable property, such as fluorescence; and combinations thereof. The choice of fiber-forming materials, fiber-coating material, or both may be made to produce a fiber reinforcement having one or more desired properties, such as a degree of thermal conductivity, a degree of thermal insulation, or a degree of electrical conductivity.

The one or more fiber reinforcements, each taken independently or together, possess a desired amount of porosity (i.e., air permeability, light permeability, and/or adhesive composition permeability) such that the fiber reinforcement does not negatively impact the ability of the structural adhesive layer to be activated by actinic radiation and fully cured without heat. The air permeability of a given fiber reinforcement may be measured by an American Standard Test Method, ASTM D737-75 or ASTM D737-80. Desirably, the one or more fiber reinforcements used in the structural adhesive layer of the structural bonding tape of the present invention possess an overall air permeability value of at least about 600 cfm/ft² (3.04 m³/m²/sec) as measured by ASTM D737-75 or ASTM D737-80. More desirably, the one or more fiber reinforcements used in the structural adhesive layer of the structural bonding tape of the present invention possess an overall air permeability value of at least about 800 cfm/ft² (4.06 m³/m²/sec) as measured by ASTM D737-75 or ASTM D737-80. Even more desirably, the one or more fiber reinforcements used in the structural adhesive layer of the structural bonding tape of the present invention possess an overall air permeability value of at least about 1000 cfm/ft² (5.07 m³/m²/sec) as measured by ASTM D737-75 or ASTM D737-80. Even more desirably, the one or more fiber reinforcements used in the structural adhesive layer of the structural bonding tape of the present invention possess an overall air permeability value of at least about 1200 cfm/ft² (6.09 m³/m²/sec) as measured by ASTM D737-75 or ASTM D737-80. Even more desirably, the one or more fiber reinforcements used in the structural adhesive layer of the structural bonding tape of the present invention possess an overall air permeability value of at least about 1300 cfm/ft² (6.59 m³/m²/sec) as measured by ASTM D737-75 or ASTM D737-80. As used herein to describe air permeability and other properties, the term “overall” refers to a particular property for a fiber reinforcement, whether the fiber reinforcement comprises one or multiple fibrous webs.

The one or more fiber reinforcements, each taken independently or together, also possess a desired amount of light permeability so that the fiber reinforcement does not negatively impact the ability of curing radiation to reach portions of the structural adhesive layer on an opposite side of the fiber reinforcement relative to a light source. The light permeability of a given fiber reinforcement may be measured by the Light Permeability Test LPT as described below. Desirably, the one or more fiber reinforcements used in the structural adhesive layer of the structural bonding tape of the present invention possess an overall light permeability value of at least about 10% as measured by the Light Permeability Test LPT. More desirably, the one or more fiber reinforcements used in the structural adhesive layer of the structural bonding tape of the present invention possess an overall light permeability value of at least about 40% as measured by the Light Permeability Test LPT. Even more desirably, the one or more fiber reinforcements used in the structural adhesive layer of the structural bonding tape of the present invention possess an overall light permeability value of at least about 70% as measured by the Light Permeability Test LPT. Even more desirably, the one or more fiber reinforcements used in the structural adhesive layer of the structural bonding tape of the present invention possess an overall light permeability value of at least about 90% as measured by the Light Permeability Test LPT.

Another feature of the one or more fiber reinforcements suitable for use in the present invention is web thickness. Fiber reinforcements suitable for use in the present invention may have a web thickness that approaches the overall thickness of the structural bonding tape as long as the fiber reinforcement allows the adhesive composition of the structural adhesive layer to be activated by actinic radiation and fully cure without heat. Typically, in relation to the overall thickness of the structural adhesive layer, the one or more fiber reinforcements used in the structural adhesive layer of the structural bonding tape of the present invention possess an overall thickness, which is less than about 50% of the overall thickness of the structural adhesive layer. In some cases, the one or more fiber reinforcements used in the structural adhesive layer of the structural bonding tape of the present invention possess an overall thickness, which is less than about 30% of the overall thickness of the structural adhesive layer. In other cases, the one or more fiber reinforcements used in the structural adhesive layer of the structural bonding tape of the present invention possess an overall thickness, which is less than about 20% of the overall thickness of the structural adhesive layer.

In structural bonding tapes of the present invention having a structural adhesive layer with an overall thickness of less than about 250 microns (10 mil), the one or more fiber reinforcements used in the structural adhesive layer typically possess an overall maximum thickness of less than about 150 microns (about 6 mil). In some structural bonding tapes of the present invention having a structural adhesive layer with an overall thickness of less than about 250 microns (10 mil), the one or more fiber reinforcements used in the structural adhesive layer possess an overall thickness of less than about 125 microns (about 5 mil). In other structural bonding tapes of the present invention having a structural adhesive layer with an overall thickness of less than about 250 microns (10 mil), the one or more fiber reinforcements used in the structural adhesive layer possess an overall thickness of less than about 100 microns (about 4 mil). In yet other structural bonding tapes of the present invention having a structural adhesive layer with an overall thickness of less than about 250 microns (10 mil), the one or more fiber reinforcements used in the structural adhesive layer possess an overall thickness of from about 25 microns (about 1 mil) to about 75 microns (about 3 mil).

A further feature of the one or more fiber reinforcements suitable for use in the present invention is web basis weight. The one or more fiber reinforcements used in the structural adhesive layer of the structural bonding tape of the present invention possess a desired overall basis weight, which provides strength and cold flow properties. Desirably, the one or more fiber reinforcements used in the structural adhesive layer of the structural bonding tape of the present invention possess an overall basis weight of less than about 40 grams per square meter (gsm). More desirably, the one or more fiber reinforcements used in the structural adhesive layer of the structural bonding tape of the present invention possess an overall basis weight of less than about 25 gsm. Even more desirably, the one or more fiber reinforcements used in the structural adhesive layer of the structural bonding tape of the present invention possess an overall basis weight of from about 4 gsm to about 17 gsm.

Another feature of the one or more fiber reinforcements is the fiber diameter of the fibers within the fiber reinforcements. In most cases, it is desirable to minimize the fiber diameter of the fibers in the one or more fiber reinforcements in order to minimize fiber volume relative to adhesive composition volume. It has been determined that fiber reinforcements containing fibers having an average fiber diameter of less than about 20 microns provide enhanced properties to the resulting structural adhesive layer, although fibers having an average fiber diameter of greater than about 20 microns are also suitable for the present invention. Desirably, the one or more fiber reinforcements used in the structural adhesive layer of the structural bonding tape of the present invention comprise fibers having an average fiber diameter of less than about 13 microns. More desirably, the one or more fiber reinforcements used in the structural adhesive layer of the structural bonding tape of the present invention comprise fibers having an average fiber diameter of less than about 10 microns. Even more desirably, the one or more fiber reinforcements used in the structural adhesive layer of the structural bonding tape of the present invention comprise fibers having an average fiber diameter of less than about 7 microns.

A number of commercially available webs are suitable for use as fiber reinforcements in the structural adhesive layer of the structural bonding tape of the present invention. Suitable webs include, but are not limited to, spunbonded polyester webs available from Reemay, Inc., Old Hickory, TN under the trade designations REEMAY™ 2250 (round cross-sectional straight fibers; basis weight of 17 gsm) and REEMAY™ 2275 (round cross-sectional straight fibers; basis weight of 25 gsm); nylon fiber webs available from Cerex Advanced Fabrics, L.P., Pensacola, Fla. under the trade designations CEREX™ 23030 (round cross-sectional straight fibers; basis weight of 10 gsm), CEREX™ 21030 (trilobal cross-sectional straight fibers; basis weight of 10 gsm), and PBN-II™ 3003 (round cross-sectional straight fibers; basis weight of 10 gsm); and a variety of polymer webs available from Technical Fibre Products Limited, Burneside Mills, UK under the trade designations TFP, such as TFP 20202A/8 (round cross-sectional straight polyester fibers; basis weight of 8 gsm), TFP A1-7-2 (round cross-sectional straight polyester microdenier fibers; basis weight of 8 gsm), TFP 206012A (round cross-sectional straight aramid fibers; basis weight of 13 gsm), TFP 20103A/5.5 (round cross-sectional straight glass fibers; basis weight of 5.5 gsm), TFP 20107A (round cross-sectional straight antistatic fibers; basis weight of 20 gsm), and TFP 20301 (round cross-sectional straight carbon fibers; basis weight of 10 gsm).

In one embodiment of the present invention, the structural bonding tape comprises a structural adhesive layer reinforced with one or more webs selected from a REEMAY™ 2250 web, a REEMAY™ 2275 web, a CEREX™ 23030 web, a CEREX™ 21030 web, a PBN-II™ 3003 web, a TFP 20202A/8 web, a TFP A1-7-2 web, a TFP 206012A web, a TFP 20103A/5.5 web, a TFP 20107A web, a TFP 20301 web, or a combination thereof. Desirably,the structural bonding tape of the present invention comprises a structural adhesive layer reinforced with a single fiber reinforcement selected from a REEMAY™ 2250 web, a CEREX™ 23030 web, a CEREX™ 21030 web, a TFP 20202A/8 web, a TFP A1-7-2 web, a TFP 206012A web, a TFP 20103A/5.5 web, a TFP 20107A web, or a TFP 20301 web. More desirably, the structural bonding tape of the present invention comprises a structural adhesive layer reinforced with a single fiber reinforcement selected from a REEMAY™ 2250 web, a CEREX™ 21030 web, or a TFP A1-7-2 web.

B. Structural Adhesive Layer Adhesive Composition

The structural adhesive layer of the structural bonding tape of the present invention further comprises an adhesive composition, which at least partially coats and/or encapsulates the one or more fiber reinforcements described above. The adhesive composition of the structural adhesive layer may contain one or more components, each of which contributes to the overall properties of the adhesive composition. Desirably, the one or more components of the structural adhesive layer are mixed to form a uniform, homogenous mixture of structural adhesive layer adhesive composition components.

i. Thermoplastic Polyesters

The structural adhesive layer of the structural bonding tape of the present invention may comprise one or more thermoplastic polyesters. Suitable polyester components include, but are not limited to, amorphous and branched polyesters having a glass transition temperature (Tg) of not more than about 10° C., and desirably not more than about 5° C. The amorphous and branched polyester component used in the present invention may be differentiated from crystalline polyesters in that the amorphous and branched polyester does not display a measurable crystalline melting behavior when an 8 gram sample is subjected to a Differential Scanning Calorimetry (DSC) scan at a rate of 20° C. per minute from −60° C. to 200° C. The DSC measurement is conveniently performed using commercially available DSC equipment such as a DSC7 differential scanning calorimeter from Perkin Elmer, Norwalk, Conn.

While not displaying a melting behavior, the amorphous and branched polyester, when being subjected to a DSC scan, displays a glass transition temperature. The temperature of glass transition of the amorphous and branched polyester is desirably less than about 10° C., and more desirably in the range of about −20° C. to about 5° C., and even more desirably between about −10°0 C. and about 5° C.

The amorphous polyester component used in the structural adhesive layer of the structural bonding tape of the present invention includes, but is not limited to, hydroxyl and carboxyl terminated polyesters. The softening point of the amorphous and branched polyester is desirably between about 50° C. and about 150° C., more desirably between about 70° C. and about 140° C., and even more desirably between about 60° C. and about 110° C. The molecular weight is desirably adjusted to give a melt flow rate at 200° C. of between about 10 g/10 min and about 300 g/10 min, and more desirably between about 20 g/10 min and about 250 g/10 min. The melt flow rate is measured according to DIN ISO 1133 by placing approximately 10 g of the respective amorphous and branched polyester compound in a temperature-conditioned metal cylinder. A cylindrical die applies a force of 21.6 N on the melted sample. The amount of sample, which flows through a standardized nozzle within a certain time, is weighed and is converted to a flow time given in g/min. Desired amorphous and branched polyesters also have a number average molecular weight of from about 5,000 to about 200,000, and more desirably from about 6,500 to about 50,000 as determined by GPC (gel permeation chromatography) in chloroform calibrated with polystyrene standards.

The amorphous and branched polyester may be prepared according to procedures well known in the art, for example, by reacting a diol, a dicarboxylic acid or a diester equivalent and, to obtain branching, a polyol having a functionality of three or more and/or a polycarboxylic acid having a functionality of three or more. The condensation reaction in the presence of these polyols and/or polycarboxylic acids having a functionality of three or more is carried out under conditions and using stoichiometric ratios such that substantial gel formation is prevented and desired branching of the polyester is obtained.

In one embodiment of the present invention, the dicarboxylic acid may be aliphatic, cycloaliphatic or aromatic. Examples of suitable aliphatic dicarboxylic acids include, but are not limited to, saturated aliphatic dicarboxylic acids, such as oxalic acid, malonic acid, succinic acid, α-methylsuccinic acid, glutaric acid, adipic acid, pimelic acid, azelaic acid, sebacic acid and dimerized linoleic acid; and unsaturated aliphatic polycarboxylic acids, such as maleic acid, fumaric acid, mesaconic acid, citraconic acid, glutaconic acid and itaconic acid, and also possible anhydrides of these acids. Examples of suitable cycloaliphatic dicarboxylic acids include, but are not limited to, hexahydrophthalic, hexahydroisophthalic or hexahydroterephthalic acid; tetrahydrophthalic, tetrahydroisophthalic or tetrahydroterephthalic acid; and 4-methyltetrahydrophthalic acid; 4-methylhexahydrophthalic acid; and endomethylenetetrahydrophthalic acid. Examples of aromatic dicarboxylic acids include, but are not limited to, phthalic, isophthalic and terephthalic acid.

Examples of polyfunctional carboxylic acids include, but are not limited to, aromatic polyfunctional carboxylic acids such as aromatic tricarboxylic or tetracarboxylic acids, such as trimellitic acid, trimesic acid, pyromellitic acid or benzophenonetetracarboxylic acid; and trimerized fatty acids or mixtures of dimerized and trimerized fatty acids, such as are available commercially, for example, under the trade name PRIPOL™ (Unichema International, New Castle, Del.).

Suitable diols include, but are not limited to, aliphatic and cycloaliphatic diols. Examples of suitable aliphatic diols include, but are not limited to, α,ω-alkylenediols, such as ethylene glycol, propane-1,2-diol, propane-1,3-diol, butane-1,4-diol, pentane-1,5-diol, neopentyl glycol, hexane-1,6-diol, octane-1,8-diol, decane-1,10-diol and dodecane-1,12-diol. Examples of suitable cycloaliphatic diols include, but are not limited to, 1,3-dihydroxycyclohexane, 1,4-dihydroxycyclohexane, 1,4-cyclohexanedimethanol, bis-4-(hydroxycyclohexyl)-methane and 2,2-bis-(4-hydroxycyclohexyl)-propane. Examples of suitable polyfunctional alcohols include, but are not limited to, 1,1,1-trimethylolethane, 1,1,1-trimethylolpropane, glycerol and pentaerythritol. Long chain diols suitable for use in the present invention include, but are not limited to, poly(oxyalkylene) glycols in which the alkylene group desirably contains from about 2 to about 9 carbon atoms (more desirably from about 2 to about 4 carbon atoms).

Reacting, for example, the dicarboxylic acids (or their diester equivalents) and the diols, polycarboxylic acids and/or polyols described above may result in amorphous and/or crystalline polyesters. An amorphous polyester compound may be easily identified by subjecting the compound to a DSC scan as described above. Amorphous rather than crystalline polyester compounds may be obtained, for example, by reacting educts with a high degree of stereo-irregularity, which cannot effectively pack into crystalline structures and impart a high degree of entropy to the resulting polymer. Details on the preparation of amorphous polymers may be found, for example, in Encyclopedia of Polymer Science and Engineering, New York, N.Y. 1988, vol. 12, pp. 1-312 and the references cited therein, and in the Polymeric Materials Encyclopedia, Boca Raton 1996, vol. 8, pp. 5887-5909 and the references cited therein.

The structural adhesive layer of the structural bonding tape of the present invention may comprise one or more thermoplastic polyesters in an amount, which varies depending on the desired properties of the structural adhesive layer. Desirably, the structural adhesive layer of the structural bonding tape of the present invention comprises one or more thermoplastic polyesters in an amount of up to about 50 weight percent, based on the total weight of the structural adhesive layer adhesive composition (i.e., the total weight of the adhesive components, which does not include the weight of any fiber reinforcements). More desirably, the structural adhesive layer of the structural bonding tape of the present invention comprises one or more thermoplastic polyesters in an amount of from about 20 weight percent to about 50 weight percent, based on the total weight of the structural adhesive layer adhesive composition, when a thermoplastic polyester resin is present. Even more desirably, the structural adhesive layer of the structural bonding tape of the present invention comprises one or more thermoplastic polyesters in an amount of from about 30 weight percent to about 40 weight percent, based on the total weight of the structural adhesive layer adhesive composition, when a thermoplastic polyester resin is present.

ii. Epoxy Resins

The structural adhesive layer of the structural bonding tape of the present invention may also comprise one or more epoxy resins. Epoxy resins useful in the present invention may be any organic compound having at least one oxirane ring, that is polymerizable by a ring opening reaction. Such materials, broadly called epoxides, include both monomeric and polymeric epoxides and may be, for example, aliphatic, alicyclic, heterocyclic, cycloaliphatic, or aromatic and may further be combinations thereof. Epoxides may be liquid or solid or blends thereof, blends being especially useful in providing tacky adhesive films. These materials generally have, on the average, at least two oxirane rings per molecule and may also be referred to as “polyepoxides.” The polymeric epoxides include, but are not limited to, linear polymers having terminal epoxy groups (for example, a diglycidyl ether of a polyoxyalkylene glycol), polymers having skeletal oxirane units (for example, polybutadiene polyepoxide), and polymers having pendent epoxy groups (for example, a glycidyl methacrylate polymer or copolymer). The molecular weight of the epoxy resin may vary from about 74 to about 100,000 or more. Mixtures of various epoxy resins may also be used in the structural adhesive layer of the present invention.

Suitable epoxy resins for use in the present invention include, but are not limited to, epoxy resins that contain cyclohexene oxide groups such as the epoxycyclohexane carboxylates, typified by 3,4-epoxycyclohexylmethyl-3,4-epoxycyclohexane carboxylate, 3,4-epoxy-2-methylcyclohexylmethyl-3,4-epoxy-2-methycyclohexane carboxylate, and bis(3,4-epoxy-6-methylcyclohexylmethyl)adipate. For a more detailed list of useful epoxides of this nature, reference may be made to U.S. Pat. No. 3,117,099.

Other epoxy resins, which are particularly suitable for use in the present invention, include glycidyl ether monomers and have a structure as shown below:

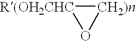

where R′ is aliphatic, such as an alkyl group, aromatic, such as an aryl group, or combinations thereof; and n is an integer from about 1 to about 6. Examples of epoxy resins having a structure as shown in Formula 1 include, but are not limited to, the glycidyl ethers of polyhydric phenols obtained by reacting a polyhydric phenol with an excess of chlorohydrin such as epichlorohydrin, for example, the diglycidyl ether of 2,2-bis-(4-hydroxyphenol)propane (Bisphenol A). Further examples of epoxides of this type are described in U.S. Pat. No. 3,018,262. Desired epoxy resins include diglycidyl ethers of bisphenol A and hydrogenated bisphenol A-epichlorohydrin based epoxy resins.

A number of commercially available epoxy resins may be used in the present invention. Epoxides, which are readily available, include, but are not limited to, octadecylene oxide; epichlorohydrin; styrene oxide; vinylcyclohexene oxide; glycidol; glycidyl methacrylate; diglycidyl ether of Bisphenol A (for example, those available under the trade designations “EPON™ 828”, “EPON™ 1004”, and “EPON™ 1001F” from Resolution Performance Products, Houston, Tex. (a new business formed from the resin unit of Shell Chemical Co., Houston, Tex.), and “DER-332” and “DER-334”, from Dow Chemical Co., Midland, Mich.); diglycidyl ether of bisphenol F (for example, those available under the trade designations “ARALDITE™ GY281” from Ciba Specialty Chemicals Holding Company, Basel, Switzerland, and “EPON™ 862” from Resolution Performance Products); vinylcyclohexane dioxide (for example, one available under the trade designation “ERL-4206” from Union Carbide Corp., Danbury, Conn.); 3,4-epoxycyclohexylmethyl-3,4-epoxycyclohexene carboxylate (for example, one available under the trade designation “ERL-4221” from Union Carbide Corp.); 2-(3,4-epoxycyclohexyl-5,5-spiro-3,4-epoxy) cyclohexane-metadioxane (for example, one available under the trade designation “ERL-4234” from Union Carbide Corp.); bis(3,4-epoxycyclohexyl) adipate (for example, one available under the trade designation “ERL-4299” from Union Carbide Corp.); dipentene dioxide (for example, one available under the trade designation “ERL-4269” from Union Carbide Corp.); epoxidized polybutadiene (for example, one available under the trade designation “OXIRON™ 2001 ” from FMC Corp., Chicago, Ill.); epoxy silanes, for example, beta-3,4-epoxycyclohexylethyltrimethoxy silane and gamma-glycidoxypropyltrimethoxy silane, commercially available from Union Carbide; flame retardant epoxy resins (for example, one available under the trade designation “DER-542”, a brominated bisphenol type epoxy resin available from Dow Chemical Co.); 1,4-butanediol diglycidyl ether (for example, one available under the trade designation “ARALDITE™ RD-2” from Ciba Specialty Chemicals); hydrogenated bisphenol A-epichlorohydrin based epoxy resins (for example, one available under the trade designation “EPONEX™ 1510” from Resolution Performance Products); and polyglycidyl ether of phenol-formaldehyde novolak (for example, one available under the trade designation “DEN-431” and “DEN-438” from Dow Chemical Co.).

The structural adhesive layer of the structural bonding tapes of the present invention desirably contains one or more epoxy resins having an epoxy equivalent weight of from about 100 to about 1000. More desirably, the structural adhesive layer of the structural bonding tapes of the present invention contains one or more epoxy resins having an epoxy equivalent weight of from about 175 to about 550. Even more desirably, the structural adhesive layer of the structural bonding tapes of the present invention contains two or more epoxy resins, wherein at least one epoxy resin has an epoxy equivalent weight of from about 175 to about 200, and at least one epoxy resin has an epoxy equivalent weight of from about 500 to about 550.

The structural adhesive layer of the structural bonding tape of the present invention may comprise one or more epoxy resins in an amount, which varies depending on the desired properties of the structural adhesive layer. Desirably, the structural adhesive layer of the structural bonding tape of the present invention comprises one or more epoxy resins in an amount of up to about 90 weight percent, based on the total weight of the structural adhesive layer adhesive composition. More desirably, the structural adhesive layer of the structural bonding tape of the present invention comprises one or more epoxy resins in an amount of from about 20 weight percent to about 80 weight percent, based on the total weight of the structural adhesive layer adhesive composition, when an epoxy resin is present. Even more desirably, the structural adhesive layer of the structural bonding tape of the present invention comprises one or more epoxy resins in an amount of from about 30 weight percent to about 60 weight percent, based on the total weight of the structural adhesive layer adhesive composition, when an epoxy resin is present.

iii. Ethylene Vinyl Acetate Copolymer

The structural adhesive layer of the structural bonding tape of the present invention may also contain one or more thermoplastic ethylene-vinyl acetate copolymer resins. Suitable thermoplastic ethylene-vinyl acetate copolymer resins include, but are not limited to, thermoplastic ethylene-vinyl acetate copolymer resins containing at least about 28 percent by weight vinyl acetate. In one embodiment of the present invention, the ethylene-vinyl acetate copolymer comprises a thermoplastic copolymer containing at least about 28 percent by weight vinyl acetate, desirably at least about 40 percent by weight vinyl acetate, more desirably at least about 50 percent by weight vinyl acetate, and even more desirably at least about 60 percent by weight vinyl acetate by weight of the copolymer. In a further embodiment of the present invention, the ethylene-vinyl acetate copolymer contains an amount of vinyl acetate ranging from about 28 to about 99 weight percent of vinyl acetate, desirably from about 40 to about 90 weight percent of vinyl acetate, more desirably from about 50 to about 90 weight percent of vinyl acetate, and even more desirably from about 60 to about 80 weight percent vinyl acetate in the copolymer.

Examples of commercially available ethylene-vinyl acetate copolymers, which may be used in the present invention include, but are not limited to, ELVAX™ 210, 250, 260, and 265 (E. I. Du Pont de Nemours and Co., Wilmington, Del.) and AT Plastics 2820M EVA copolymer (AT Plastics, Inc., Brampton, Ontario, Canada) (28 weight percent vinyl acetate); ELVAX™ 150 (E. I. Du Pont de Nemours and Co., Wilmington, Del.) and AT Plastics 3325M EVA copolymer (AT Plastics, Inc., Brampton, Ontario, Canada) (33 weight percent vinyl acetate); ELVAX™ 40W (E. I. Du Pont de Nemours and Co., Wilmington, Del.), LEVAPREN™ 400 (Bayer Corp., Pittsburgh, Pa.), and AT Plastics 4030M (AT Plastics, Inc., Brampton, Ontario, Canada) (40 weight percent vinyl acetate); LEVAPREN™450, 452, and 456 (Bayer Corp., Pittsburgh, Pa.) (45 weight percent vinyl acetate); LEVAPREN™ 500 HV (Bayer Corp., Pittsburgh, Pa.) (50 weight percent vinyl acetate); LEVAPREN™ 600 HV (Bayer Corp., Pittsburgh, Pa.) (60 weight percent vinyl acetate); LEVAPREN™700 HV (Bayer Corp., Pittsburgh, Pa.) (70 weight percent vinyl acetate); and LEVAPREN™ KA 8479 (Bayer Corp., Pittsburgh, Pa.) (80 weight percent vinyl acetate).

The structural adhesive layer of the structural bonding tape of the present invention may comprise one or more ethylene-vinyl acetate copolymer resins in an amount, which varies depending on the desired properties of the structural adhesive layer. Desirably, the structural adhesive layer of the structural bonding tape of the present invention comprises one or more ethylene-vinyl acetate copolymer resins in an amount of up to about 40 weight percent, based on the total weight of the structural adhesive layer adhesive composition. More desirably, the structural adhesive layer of the structural bonding tape of the present invention comprises one or more ethylene-vinyl acetate copolymer resins in an amount of from about 20 weight percent to about 35 weight percent, based on the total weight of the structural adhesive layer adhesive composition, when an ethylene-vinyl acetate copolymer resin is present. Even more desirably, the structural adhesive layer of the structural bonding tape of the present invention comprises one or more ethylene-vinyl acetate copolymer resins in an amount of from about 25 weight percent to about 30 weight percent, based on the total weight of the structural adhesive layer adhesive composition, when an ethylene-vinyl acetate copolymer resin is present.

iv. (Meth)Acrylates

The structural adhesive layer of the structural bonding tape of the present invention may also contain one or more thermoplastic (meth)acrylate resins. The (meth)acrylate resins may be made by a variety of polymerization methods, including bulk, solution, suspension, emulsion and photopolymerization. The (meth)acrylate resins are desriably compatible with each other and with other adhesive constituents. Desirably, the (meth)acrylate resin used in the present invention is a poly(meth)acrylate elastomer having an olefin (e.g., ethylene, propylene or butylene) repeating unit, the molar ratio of such olefin units to (meth)acrylate repeating units typically being less than about 2, desirably being in the range from about 0.5 to about 1.5.

(Meth)acrylic monomers suitable for making the thermoplastic (meth)acrylate resins used in the structural adhesive layer of the structural bonding tape of the present invention include, but are not limited to, monomers from the following classes:

Class A—acrylic acid esters of an alkyl alcohol (desirably a non-tertiary alcohol), wherein the alcohol contains from 1 to about 14 (desirably from about 4 to about 14) carbon atoms and include, for example, methyl acrylate, ethyl acrylate, n-butyl acrylate, t-butyl acrylate, hexyl acrylate, isooctyl acrylate, 2-ethylhexyl acrylate, isononyl acrylate, isobornyl acrylate, phenoxyethyl acrylate, decyl acrylate, and dodecyl acrylate;

Class B—methacrylic acid esters of an alkyl alcohol (desirably a non-tertiary alcohol), wherein the alcohol contains from about 1 to about 14 (desirably from about 4 to about 14) carbon atoms and include, for example, methyl methacrylate, ethyl methacrylate, n-propyl methacrylate, n-butyl methacrylate, isobutyl methacrylate and t-butyl methacrylate;

Class C—(meth)acrylic acid monoesters of polyhydroxy alkyl alcohols such as 1,2-ethanediol, 1,2-propanediol, 1,3-propane diol, any of the various butyl diols, any of the various hexanediols, glycerol, such that the resulting esters are referred to as hydroxyalkyl (meth)acrylates;

Class D—multifunctional (meth)acrylate esters, such as 1,4-butanediol diacrylate, 1,6-hexanediol diacrylate, glycerol diacrylate, glycerol triacrylate, and neopentyl glycol diacrylate; however, these monomers are generally not desired for reactive extrusion or melt blending;

Class E—macromeric (meth)acrylates, such as (meth)acrylate-terminated styrene oligomers and (meth)acrylate-terminated polyethers, such as those described in PCT Patent Application WO 84/03837 and European Patent Application EP 140941; and

Class F—(meth)acrylic acids and their salts with alkali metals, including, for example, lithium, sodium, and potassium, and their salts with alkaline earth metals, including, for example, magnesium, calcium, strontium, and barium.

Bifunctional monomers may also be used to prepare the (meth)acrylates suitable for use in the present invention. Typically, the bifunctional monomers possess at least one free radical and one cationically reactive functionality per monomer. Examples of such monomers include, but are not limited to, glycidyl (meth)acrylate, hydroxyethyl (meth)acrylate, hydroxypropyl methacrylate and hydroxybutyl acrylate.

Examples of commercially available (meth)acrylate resins suitable for use in the present invention include, but are not limited to, curable acrylate resins sold under the trade designations HYTEMP™ and NIPOL™, both of which are available from Zeon Chemicals Company, Inc., Louisville, Ky. The HYTEMP™ and NIPOL™ series of polyacrylates includes polyacrylates such as HYTEMP™4051, and 4051EP, and NIPOL™ AR-31 (Zeon Chemicals Company, Inc., Louisville, Ky.). Other commercially available acrylate resins suitable for use in the present invention include, but are not limited to, the VAMAC™ series of ethylene/acrylic elastomers, such as VAMAC™ G and VAMAC™ D (DuPont Packaging and Industrial Polymers, Wilmington, Del.); the LOTADER™ and LOTARYL™ (Atofina Chemicals Inc., Philadelphia, Pa.) series of acrylic elastomers and ethylene-acrylic ester copolymers, such as LOTADER™ 4700 and LOTARYL™ 35BA320, 35MA03 and 35MA05 (Atofina Chemicals Inc., Philadelphia, Pa.); the EUROPRENE™ series of acrylic rubber, such as EUROPRENE™ AR53 EP, AR 156 LTR, EUROPRENE™ C, L and R (EniChem America Inc., Houston, Tex.).

The structural adhesive layer of the structural bonding tape of the present invention may comprise one or more (meth)acrylate resins in an amount, which varies depending on the desired properties of the structural adhesive layer. Desirably, the structural adhesive layer of the structural bonding tape of the present invention comprises one or more (meth)acrylate resins in an amount of up to about 40 weight percent, based on the total weight of the structural adhesive layer adhesive composition. More desirably, the structural adhesive layer of the structural bonding tape of the present invention comprisesone or more (meth)acrylate resins in an amount of from about 20 weight percent to about 35 weight percent, based on the total weight of the structural adhesive layer adhesive composition, when a (meth)acrylate resin is present. Even more desirably, the structural adhesive layer of the structural bonding tape of the present invention comprises one or more (meth)acrylate resins in an amount of from about 25 weight percent to about 30 weight percent, based on the total weight of the structural adhesive layer adhesive composition, when a (meth)acrylate resin is present.

V. Hydroxyl-Functional or Hydroxyl-Containing Material

The structural adhesive layer may also contain at least one hydroxyl-functional or hydroxyl-containing material. As used herein, the terms “hydroxyl-functional material” and “hydroxyl-containing material” are used to represent compounds having at least one and desirably at least two hydroxyl groups. The terms “hydroxyl-functional material” and “hydroxyl-containing material” are used interchangeably. Further, the terms “hydroxyl-functional material” and “hydroxyl-containing material” do not include the amorphous and branched polyester resins described above, which may also contain one or more hydroxyl groups. Desirably, the hydroxyl-containing materials are substantially free of other “active hydrogen” containing groups such as amino and mercapto moieties. Further, the hydroxyl-containing materials are also desirably substantially free of groups, which may be thermally and/or photolytically unstable so that the compounds will not decompose or liberate volatile components when exposed to actinic radiation and/or heat during curing. Desirably, the hydroxyl-containing materials contain two or more primary or secondary aliphatic hydroxyl groups (i.e., the hydroxyl group is bonded directly to a non-aromatic carbon atom). The hydroxyl group may be terminally situated, or may be pendent from a polymer or copolymer. The number average equivalent weight of the hydroxyl-containing material is desirably from about 31 to about 2500, more desirably from about 80 to about 1000, and even more desirably from about 80 to about 350.

The hydroxyl number, OH#, of a given hydroxyl-containing compound may be defined by the following equation:

OH#=(56.1×1000×f)/(m.w.)

wherein

f=functionality, that is, the average number of hydroxyl groups per molecule of hydroxyl-containing compound; and

m.w.=the number average molecular weight of the hydroxyl-containing compound.

Examples of suitable hydroxyl-containing materials for use in the present invention include, but are not limited to, both monomeric and polymeric compounds. Suitable monomeric hydroxyl-containing materials include, but are not limited to, ethylene glycol; propylene glycol; 1,2-dihydroxypropane; 1,3-dihydroxypropane; 1,3-dihydroxybutane; 1,4-dihydroxybutane; 1,4-, 1,5-, and 1,6-dihydroxyhexane; 1,2-, 1,3-, 1,4-, 1,6-, and 1,8-dihydroxyoctane; 1,10-dihydroxydecane; 1,1,1-trimethylolethane; 1,1,1-trimethylolpropane; N,N-bis(hydroxyethyl)benzamide; castor oil; pentaerythritol; polycaprolactone; xylitol; arabitol; sorbitol; and mannitol. Suitable polymeric hydroxyl-containing materials include, but are not limited to, polyoxyalkylene polyols (e.g., polyoxyethylene and polyoxypropylene glycols and triols having an equivalent weight of from about 31 to about 2500 for diols, and from about 80 to about 350 for triols); polytetramethylene oxide glycols of varying molecular weight; and hydroxyl-terminated polyacetones.

Commercially available hydroxyl-containing materials suitable for use in the present invention include, but are not limited to, the POLYMEG™ series (available from Penn Specialty Chemicals, Inc., Memphis, Tenn.) of polytetramethylene oxide glycols such as POLYMEG™ 650, 1000 and 2000; the TERATHANE™ series (from E.l. duPont de Nemours and Company, Wilmington, Del.) of polytetramethylene oxide glycols such as TERATHANE™ 650, 1000 and 2000; POLYTHF™, a polytetramethylene oxide glycol from BASF Corp. (Charlotte, N.C.); the BUTVAR™ series (available from Solutia, Inc., St. Louis, Mo.) of polyvinylacetal resins such as BUTVAR™B-72A, 8-73, 8-76, 8-90 and 8-98; the TONE™ series (available from Union Carbide, Danbury, Conn.) of polycaprolactone polyols such as TONE™ 0200, 0210, 0230, 0240, and 0260; the DESMOPHEN™ series (available from Bayer Corporation, Pittsburg, Pa.) of saturated polyester polyols such as DESMOPHEN™ 631A 75, 650A 65, 651A 65, 670A 80, 680 70, 800, 1100, 1150, 1300 75, 1300 75 BA, 1652A, 1700, 1800, R 12A, R 221 75, A 160 SN, A 365, A 450 BA/X, 550 U, 1600 U, 1900 U, 1915 U, 1920 U, NH 1220, NH 1420, and NH 1521; VORANOL™ 234-630 (a trimethylol propane) from Dow Chemical Company (Midland, Mich.); VORANOL™ 230-238 (a glycerol polypropylene oxide adduct) from Dow Chemical Company; the SYNFAC™ series (from Milliken Chemical, Spartanburg, S.C.) of polyoxyalkylated bisphenol A's such as SYNFAC™ 8009, 773240, 8024, 8027, 8026, and 8031; and the ARCOL™ series (from Arco Chemical Co., Los Angeles, Calif.) of polyoxypropylene polyols such as ARCOL™ 425, 1025, 2025, 42, 112, 168, and 240; and bisphenol-A extended polyols such as SIMULSOL™ BPHE, BPIE, BPJE, BPLE, BPNE, BPRE, BPHP, BPIP, BPRP and BPUP from Seppic (Paris, France). Other useful commercially available hydroxyl-containing materials include those described in U.S. Pat. No. 5,436,063.

A particularly useful class of hydroxyl-containing compounds is the polyoxyalkylene polyols. Examples of this class of hydroxyl-containing compounds include, but are not limited to, polyoxyethylene and polyoxypropylene glycols; polyoxyethylene and polyoxypropylene triols; polytetramethylene oxide glycols; and polyoxyalkylated bisphenol A's. The polyoxyalkylene polyols are particularly suitable for retarding the curing reaction so that the “open time” of the structural adhesive layer can be increased. As used herein, the term “open time” is used to mean the period of time after an adhesive composition has been irradiated, during which time the adhesive composition remains sufficiently uncured for a second substrate to be bonded thereto. The open time of the structural adhesive layer is desirably at least 2 minutes after exposure to an energy dose of about 1.640 J/cm² of actinic radiation. However, if one or both substrates that are being bonded together are translucent for the radiation to which the structural adhesive layer is to be exposed, the open time is of no relevance because in that case the exposure to the radiation can be effected through the translucent substrate after both substrates have been attached to each other by the structural bonding tape. When both substrates of the assembly are opaque, the structural bonding tape will be exposed to actinic radiation prior to attaching the second substrate thereto. In this case, an open time of at least 2 minutes is desirable to allow for suitable workability of the structural adhesive layer.

Another desirable class of hydroxyl-containing compounds for use in the present invention is hydroxy-containing phenoxy resins. Particularly desirable phenoxy resins are those that are derived from the polymerization of a di-glycidyl bisphenol compound. Typically, the phenoxy resin has a number average molecular weight of less than 50,000, desirably in the range of about 10,000 to about 20,000. Commercially available phenoxy resins suitable for use in the present invention include, but are not limited to, PAPHEN™ PKHP-200, available from Phenoxy Associates (Rock Hill, S.C.). It has been found that the addition of a phenoxy resin to the structural adhesive composition may improve the dynamic overlap shear strength, decrease the cold flow and/or improve the impact resistance of the adhesive layer.

The structural adhesive layer of the structural bonding tape of the present invention may comprise one or more hydroxyl-containing materials in an amount, which varies depending on the desired properties of the structural adhesive layer. Desirably, the structural adhesive layer of the structural bonding tape of the present invention comprises one or more hydroxyl-containing materials in an amount of up to about 40 weight percent, based on the total weight of the structural adhesive layer adhesive composition. More desirably, the structural adhesive layer of the structural bonding tape of the present invention comprises one or more hydroxyl-containing materials in an amount of from about 1 weight percent to about 35 weight percent, based on the total weight of the structural adhesive layer adhesive composition, when a hydroxyl-containing material is present. Even more desirably, the structural adhesive layer of the structural bonding tape of the present invention comprises one or more hydroxyl-containing materials in an amount of from about 3 weight percent to about 30 weight percent, based on the total weight of the structural adhesive layer adhesive composition, when a hydroxyl-containing material is present.

vi. Photoinitiators

Photoinitiators for use in the present invention are desirably activated by photochemical means, such as by actinic radiation (i.e., radiation having a wavelength in the ultraviolet or visible portion of the electromagnetic spectrum). Suitable photoinitiators include, but are not limited to, onium salts and cationic organometallic salts, both of which are described in U.S. Pat. No. 5,709,948.

Suitable onium salt photoinitiators for use in the present invention include, but are not limited to, iodonium and sulfonium complex salts. Useful aromatic iodonium complex salts include salts having the following general formula:

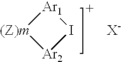

wherein

Ar₁ and Ar₂ are the same or different and each independently comprise an aromatic group having from about 4 to about 20 carbon atoms;

Z is selected from the group consisting of oxygen, sulfur, a carbon-carbon bond,

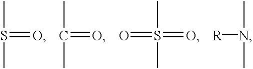

wherein R may be aryl (having from about 6 to about 20 carbon atoms, such as phenyl) or acyl (having from about 2 to about 20 carbon atoms, such as acetyl, or benzoyl), and

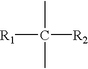

wherein R₁ and R₂ are selected from the group consisting of hydrogen, alkyl radicals having from about 1 to about 4 carbon atoms, and alkenyl radicals having from about 2 to about 4 carbon atoms;

m is zero or 1; and

X has the formula DQₙ, wherein D is a metal from Groups IB to VIII or a metalloid from Groups IIIA to VA of the Periodic Chart of the Elements (Chemical Abstracts version); Q is a halogen atom; and n is an integer having a value of from 1 to 6. Desirably, the metals are copper, zinc, titanium, vanadium, chromium, magnesium, manganese, iron, cobalt, or nickel, and the metalloids desirably are boron, aluminum, antimony, tin, arsenic and phosphorous. Desirably, the halogen, Q, is chlorine or fluorine. Examples of suitable anions include, but are not limited to, BF₄⁻, PF₆⁻, SbF₆⁻, FeCl₄⁻, SnCl₅⁻, AsF₆⁻, SbF₅OH⁻, SbCl₆⁻, SbF₅⁻², AlF₅⁻², GaCl₄⁻, InF₄⁻, TiF₆⁻², ZrF₆⁻, and CF₃SO₃⁻. Desirably, the anions are BF₄⁻, PF₆⁻, SbF₆⁻, AsF₆⁻, SbF₅OH⁻, and SbCl₆⁻. More desirably, the anions are SbF₆⁻, AsF₆⁻, and SbF₅OH⁻.

Desirably, Ar₁ and Ar₂ are selected from the group consisting of phenyl, thienyl, furanyl, and pyrazolyl groups. Ar₁ and Ar₂ groups may optionally comprise one or more fused benzo rings (for example, naphthyl, benzothienyl, dibenzothienyl, benzofuranyl, dibenzofuranyl, etc.). The aromatic groups may also be substituted, if desired, by one or more non-basic groups if they are essentially non-reactive with epoxide and hydroxyl functionalities.

Suitable aromatic iodonium complex salts are described more fully in U.S. Pat. No. 4,256,828. In one embodiment of the present invention, the desired aromatic iodonium complex salt is [(Ar)₂I]⁺[PF₆]⁻ or [(Ar)₂I]⁺[SbF₆]⁻.

The aromatic iodonium complex salts useful in the present invention are photosensitive in the ultraviolet region of the spectrum. However, they can be sensitized to the near ultraviolet and the visible range of the spectrum by sensitizers for known photolyzable organic halogen compounds. Illustrative sensitizers include colored aromatic polycyclic hydrocarbons, as described in U.S. Pat. No. 4,250,053. Suitable sensitizers should be chosen so as to not interfere appreciably with the cationic cure of the epoxy resin in the adhesive composition.

Aromatic sulfonium complex salt initiators suitable for use in the present invention may be given by the general formula:

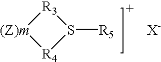

wherein

R₃, R₄, and R₅ are the same or different, provided that at least one of R₃, R₄, and R₅ is aromatic. R₃, R₄, and R₅ may be selected from the group consisting of aromatic moieties having from about 4 to about 20 carbon atoms (for example, substituted and unsubstituted phenyl, thienyl, and furanyl) and alkyl radicals having from 1 to about 20 carbon atoms. The term “alkyl” includes substituted alkyl radicals (for example, substituents such as halogen, hydroxy, alkoxy, and aryl). Desirably, R₃, R₄, and R₅ are each independently aromatic moieties; and

Z, m, and X are all as defined above with regard to the iodonium complex salts.

If R₃, R₄, or R₅ is an aromatic group, it may optionally have one or more fused benzo rings (for example, naphthyl, benzothienyl, dibenzothienyl, benzofuranyl, dibenzofuranyl, etc.). The aromatic groups may also be substituted, if desired, by one or more non-basic groups if they are essentially non-reactive with epoxide and hydroxyl functionalities.

In one embodiment of the present invention, triaryl-substituted salts such as triphenylsulfonium hexafluoroantimonate and p-(phenyl(thiophenyl)diphenylsulfonium hexafluoroantimonate are the desired sulfonium salts. Other sulfonium salts useful in the present invention are described more fully in U.S. Pat. Nos. 5,256,828 and 4,173,476.

Aromatic sulfonium complex salts useful in the present invention are typically photosensitive in the ultraviolet region of the spectrum. However, they can be sensitized to the near ultraviolet and the visible range of the spectrum by a select group of sensitizers such as described in U.S. Pat. Nos. 4,256,828 and 4,250,053.

If a sensitizer is used in combination with an iodonium or sulfonium salt as described above, it should be chosen so as to not interfere appreciably with the cationic cure of the epoxy resin in the adhesive composition.

Another class of photoinitiators suitable for use in the present invention comprises photoactivatable organometallic complex salts such as those described in U.S. Pat. Nos. 5,059,701; 5,191,101; and 5,252,694. Such salts of organometallic cations have the general formula:

[(L¹)(L²)M^{m}]^{+e}X⁻

wherein

M^{m} represents a metal atom selected from elements of periodic groups IVB, VB, VIB, VIIB, and VIII, desirably Cr, Mo, W, Mn, Re, Fe, and Co;

L¹ represents none, one, or two ligands contributing π-electrons, wherein the ligands may be the same or different, and each ligand may be selected from the group consisting of substituted and unsubstituted alicyclic and cyclic unsaturated compounds and substituted and unsubstituted carbocyclic aromatic and heterocyclic aromatic compounds, each capable of contributing two to twelve π-electrons to the valence shell of the metal atom M. Desirably, L¹is selected from the group consisting of substituted and unsubstituted η³-allyl, η⁵-cyclopentadienyl, η⁷-cycloheptatrienyl compounds, and η⁶-aromatic compounds selected from the group consisting of η⁶-benzene and substituted η⁶-benzene compounds (for example, xylenes) and compounds having 2 to 4 fused rings, each capable of contributing 3 to 8 π-electrons to the valence shell of M^{m};

L² represents none or 1 to 3 ligands contributing an even number of σ-electrons, wherein the ligands may be the same or different, and each ligand may be selected from the group consisting of carbon monoxide, nitrosonium, triphenyl phosphine, triphenyl stibine and derivatives of phosphorous, arsenic and antimony, with the proviso that the total electronic charge contributed to M^{m} by L¹ and L²results in a net residual positive charge of e to the complex;

e is an integer having a value of 1 or 2, the residual charge of the complex cation; and

X is a halogen-containing complex anion, as described above.

Examples of suitable salts of organometallic complex cations useful as photoactivatable catalysts in the present invention include, but are not limited to,

[(η⁶-benzene)(η⁵-cyclopentadienyl)Fe]⁺¹[SbF₆]⁻,

[(η⁶-toluene)(η⁵-cyclopentadienyl)Fe]⁺¹[AsF₆]⁻,

[(η⁶-xylene)(η⁵-cyclopentadienyl)Fe]⁺¹[SbF₆]⁻,

[(η⁶-cumene)(η⁵-cyclopentadienyl)Fe]⁺¹[PF₆]⁻,

[(η⁶-xylenes (mixed isomers))(η⁵-cyclopentadienyl)Fe]⁺¹[SbF₆]⁻,

[(η⁶-xylenes (mixed isomers))(η⁵-cyclopentadienyl)Fe]⁺¹[PF₆]⁻,

[(η⁶-o-xylene)(η⁵-cyclopentadienyl)Fe]⁺¹[CF₃SO₃]⁻,

[(η⁶-m-xylene)(η⁵-cyclopentadienyl)Fe]⁺¹[BF₄]⁻,

[(η⁶-mesitylene)(η⁵-cyclopentadienyl)Fe]⁺¹[SbF₆]⁻,

[(η⁶-hexamethylbenzene)(η⁵-cyclopentadienyl)Fe]^{+1[SbF}₅OH]⁻, and

[(η⁶-fluorene)(η⁵-cyclopentadienyl)Fe]⁺¹[SbF₆]⁻.

In one embodiment of the present invention, desired salts of organometallic complex cations comprise one or more of the following:

[(η⁶-xylenes (mixed isomers))(η⁵-cyclopentadienyl)Fe]⁺¹[SbF₆]⁻,

[ (η⁶-xylenes (mixed isomers))(n⁵-cyclopentadienyl)Fe]⁺¹[PF₆]⁻,

[ (η⁶-xylene)(η⁵-cyclopentadienyl)Fe]⁺¹[SbF₆]⁻, and

[ (η⁶-mesitylene)(η⁵-cyclopentadienyl)Fe]⁺¹[SbF₆]⁻.

Suitable commercially available initiators include, but are not limited to, aromatic sulfonium complex salts FX-512™ (Minnesota Mining and Manufacturing Company, St. Paul, Minn.), CD-1012™ and CD-1010™ (Sartomer, Exton, Pa.); UVOX™ UVI-6974, an aromatic sulfonium complex salt (Union Carbide Corp., Danbury, Conn.); and IRGACURE™ 261, a cationic organometallic complex salt (Ciba Specialty Chemicals, Basel, Switzerland).

Where the catalytic photoinitiator used for curing the structural adhesive layer is a metallocene salt catalyst, it optionally is accompanied by an accelerator such as an oxalate ester of a tertiary alcohol as described in U.S. Pat. No. 5,436,063, although this is optional. Oxalate co-catalysts that may be used include those described in U.S. Pat. No. 5,252,694. The accelerator may comprise from about 0.01 to about 5 weight percent, desirably from about 0.1 to about 4 weight percent of the structural adhesive layer composition, based on the total weight of the resin (polyester, epoxy, EVA and/or acrylate) present in the composition.

The structural adhesive layer of the structural bonding tape of the present invention may comprise one or more photoinitiators in an amount, which varies depending on the light source and the degree of exposure. Desirably, the structural adhesive layer of the structural bonding tape of the present invention comprises one or more photoinitiators in an amount of up to about 3 weight percent, based on the total weight of the structural adhesive layer adhesive composition. More desirably, the structural adhesive layer of the structural bonding tape of the present invention comprises one or more photoinitiators in an amount of from about 0.5 weight percent to about 2 weight percent, based on the total weight of the structural adhesive layer adhesive composition, when a photoinitiator is present. Even more desirably, the structural adhesive layer of the structural bonding tape of the present invention comprises one or more photoinitiators in an amount of from about 1 weight percent to about 2 weight percent, based on the total weight of the structural adhesive layer adhesive composition, when a photoinitiator is present.

vii. Other Additives

The structural adhesive layer adhesive composition may further comprise up to about 50 weight percent, desirably, up to about 10 percent, of various additives such as fillers, stabilizers, plasticizers, tackifiers, flow control agents, cure rate retarders, adhesion promoters (for example, silanes and titanates), adjuvants, impact modifiers, expandable microspheres, thermally conductive particles, electrically conductive particles, and the like, such as silica, glass, clay, talc, pigments, colorants, glass beads or bubbles, and antioxidants, so as to reduce the weight and/or cost of the structural adhesive layer composition, adjust viscosity, and/or provide additional reinforcement or modify the thermal conductivity of the adhesive compositions and articles of the present invention so that a more rapid or uniform cure may be achieved.

In one embodiment of the present invention, an additive in the form of acrylic core/shell particles is added to the structural adhesive layer composition as an impact modifier. The acrylic core/shell particles may be added in an amount of up to about 20 weight percent based on the total weight of the structural adhesive layer adhesive composition. Desirably, the acrylic core/shell particles are added in an amount of up to about 10 weight percent based on the total weight of the structural adhesive layer adhesive composition. One commercially available product suitable for use in the present invention is an acrylic core/shell impact modifier available under the trade designation, ZEON™ F-351, from Zeon Chemicals Co. Inc. (Louisville, Ky.).

II. Other Adhesive Layers

In addition to the structural adhesive layer described above, the structural bonding tape of the present invention may include one or more additional non-structural adhesive layers on either side of the structural bonding tape. As used herein, the term “non-structural” is used to describe an adhesive layer, which does not contain a fiber reinforcement in the form of a web as described above. It should be noted that the one or more additional non-structural adhesive layers may contain filler materials as described above.

The one or more additional non-structural adhesive layers may be any suitable adhesive as is known in the art. Desirably, the non-structural adhesive layer, when present, is an adhesive, which is activatable by pressure, heat or a combination thereof. Suitable non-structural adhesive layer compositions include, but are not limited to, adhesive compositions based on (meth)acrylates, rubber/resins, epoxies, urethanes or combinations thereof. The non-structural adhesive layer may be applied to an outer surface of the structural adhesive layer by solution, water-based or hot-melt coating methods. The non-structural adhesive layer may include hot melt-coated formulations, transfer-coated formulations, solvent-coated formulations, and latex-coated formulations, as well as laminating, thermally-activated, and water-activated adhesives and bonding agents. More desirably, the non-structural adhesive layer comprises a pressure sensitive adhesive. Pressure sensitive adhesives are well known to possess properties including: aggressive and permanent tack, adherence with no more than finger pressure, and sufficient ability to hold onto an adherend.

Examples of suitable pressure sensitive adhesives useful in the non-structural adhesive layer include, but are not limited to, adhesives based on general compositions of poly(meth)acrylate; polyvinyl ether; diene rubber such as natural rubber, polyisoprene, and polybutadiene; polyisobutylene; polychloroprene; butyl rubber;butadiene-acrylonitrile polymer; thermoplastic elastomer; block copolymers such as styrene-isoprene and styrene-isoprene-styrene (SIS) block copolymers, ethylene-propylene-diene polymers, and styrene-butadiene polymers; poly-alpha-olefin; amorphous polyolefin; silicone; ethylene-containing copolymer such as ethylene vinyl acetate, ethylacrylate, and ethyl methacrylate; polyurethane; polyamide; epoxy; polyvinylpyrrolidone and vinylpyrrolidone copolymers; polyesters; and mixtures or blends (continuous or discontinuous phases) of the above. As discussed above, the non-structural adhesive layer adhesive composition may contain additives including, but not limited to, tackifiers, plasticizers, fillers, antioxidants, stabilizers, pigments, diffusing materials, curatives, fibers, filaments, and solvents.

A general description of useful pressure sensitive adhesives may be found in Encyclopedia of Polymer Science and Engineering, Vol. 13, Wiley-Interscience Publishers (New York, 1988). Additional description of useful pressure sensitive adhesives may be found in Encyclopedia of Polymer Science and Technology, Vol. 1, Interscience Publishers (New York, 1964).

In one embodiment of the present invention, the structural bonding tape comprises one structural adhesive layer in combination with at least one non-structural adhesive layer, wherein the at least one non-structural adhesive layer is present on an outer surface of the structural adhesive layer in the form of a continuous or discontinuous coating. When the non-structural adhesive layer is present as a discontinuous coating, the non-structural adhesive layer may be present as dots, squares, triangles, lines, or any other configuration along the outer surface of the structural adhesive layer.

III. Release Liners

In addition to the structural and non-structural adhesive layers described above, the structural bonding tape of the present invention may include one or more release liners to protect an outer surface of an adhesive layer. Release liners are well known in the art, and any known release liner may be used in the present invention. Typically, the release liner comprises a film or paper substrate coated with a release material.

Commercially available release liners suitable for use in the present invention include, but are not limited to, silicon coated paper, and silicon coated films, such as polyester films. Examples of suitable release liners include, but are not limited to, release liners sold under the trade designation AKROSIL™ available from Akrosil Europe (Huerlen, Netherlands) and International Paper (Menasha, Wis.); and release liners available from Daubert Coated Products, Inc. (Dixon, Ill.). Desirably, the release liner comprises AKROSIL™ Paper Liner ZG-3223 (Akrosil Europe, Huerlen, Netherlands) or AKROSIL™ Paper Liner SBL 60 SC SILOX F1U/F4B (International Paper, Menasha, Wis.). More desirably, the release liner comprises AKROSIL™ Paper Liner ZG-3223 (Akrosil Europe, Huerlen, Netherlands).

IV. Other Possible Layers

The structural bonding tape of the present invention may also include one or more additional layers, which may provide temporary or permanent properties to the structural bonding tape. Suitable additional layers may be positioned on one or both sides of the structural adhesive layer of the structural bonding tape as long as the structural bonding tape is curable by actinic radiation from at least one side of the structural bonding tape. In other words, if both sides of the structural adhesive layer of the structural bonding tape are covered by an additional layer, at least one of the additional layers should be transparent such that actinic radiation penetrates the additional layer in an amount sufficient for curing the structural adhesive layer.

Desirably, the one or more additional layers are flexible such that the resulting structural bonding tape may be rolled into a roll as shown in FIG. 2. The one or more additional layers may function as tie layers, primer layers, or barrier layers. Suitable additional layers include, but are not limited to, polymer films, metal foils, papers, foam sheets, and fabrics, such as the fiber-containing webs described above. The one or more additional layers may be attached to the structural adhesive layer by a pressure-sensitive adhesive as described above or by the structural adhesive layer composition itself.

Specific Structural Bonding Tapes

The structural bonding tapes of the present invention may comprise a variety of layers and adhesive components as described above. In one desired embodiment of the present invention, the structural bonding tape comprises a single structural adhesive layer and a release liner on an outer surface of the structural adhesive layer. An example of this desired structural bonding tape is shown in FIG. 2. The structural bonding tape 20 of FIG. 2 comprises a structural adhesive layer 21 containing a fiber reinforcement 22, and a release liner 23 on outer surface 24 of structural adhesive layer 21. When in roll form, exposed surface 26 of the structural adhesive layer 21 comes into contact with outer surface 25 of the release liner 23.

In one embodiment of the present invention, the structural bonding tape comprises a structural adhesive layer, which is activatable upon exposure to actinic radiation, and comprises (a) a layer of adhesive material, wherein the adhesive material is a mixture of (i) about 20 to about 80 weight percent of one or more epoxy resins, (ii) about 50 to about 20 weight percent of one or more resins selected from polyester resins, ethyl vinyl acetate resins, and (meth)acrylate resins, (iii) up to about 30 weight percent of one or more hydroxy-containing compounds, (iv) up to about 5 weight percent of one or more photoinitiators, and (v) up to about 50 weight percent of one or more additives, wherein all weight percentages are based on a total weight of the mixture; and (b) at least one web of fibers at least partially embedded within the layer of adhesive material, wherein the at least one web of fibers has a basis weight of less than about 30 grams per square meter, an air permeability value of more than about 600 cfm/ft² (3.04 m³/m²/sec) as measured by ASTM D737-75 or ASTM D737-80, a light permeability value of more than about 10% as measured by Light Permeability Test LPT, and comprises fibers having an average fiber diameter of less than about 20 microns.

In a further embodiment of the present invention, the structural bonding tape comprises a structural adhesive layer, which is activatable upon exposure to actinic radiation, and comprises (a) a layer of adhesive material, wherein the adhesive material is a mixture of (i) about 30 to about 60 weight percent of one or more epoxy resins, (ii) about 40 to about 30 weight percent of one or more resins selected from polyester resins, ethyl vinyl acetate resins, and (meth)acrylate resins, (iii) about 20 to about 9 weight percent of one or more hydroxy-containing compounds, (iv) up to about 2 weight percent of one or more photoinitiators, and (v) up to about 10 weight percent of one or more additives, wherein all weight percentages are based on the total weight of the mixture; and (b) at least one web of fibers at least partially embedded within the layer of adhesive material, wherein the at least one web of fibers comprises a fiber reinforcement as described above.

In another embodiment of the present invention, the structural bonding tape comprises a structural adhesive layer, which is activatable upon exposure to actinic radiation, and comprises (a) a layer of adhesive material, wherein the adhesive material is a mixture of (i) about 30 to about 60 weight percent of one or more epoxy resins, (ii) about 40 to about 30 weight percent of polyester resin, (iii) about 20 to about 9 weight percent of one or more hydroxy-containing compounds, and (iv) up to about 1 weight percent of one or more photoinitiators, wherein all weight percentages are based on the total weight of the mixture; and (b) at least one web of fibers at least partially embedded within the layer of adhesive material, wherein the at least one web of fibers comprises a fiber reinforcement as described above.

In yet another embodiment of the present invention, the structural bonding tape comprises a structural adhesive layer, which is activatable upon exposure to actinic radiation, and comprises (a) a layer of adhesive material, wherein the adhesive material is a mixture of (i) about 27 weight percent of a first epoxy resin having an epoxy equivalent weight of about 185 to about 192, and about 22 weight percent of a second epoxy resin having an epoxy equivalent weight of about 525 to about 550, (ii) about 30 weight percent of a polyester resin, wherein the polyester resin is an amorphous branched copolyester having a glass transition temperature of less than about −5° C., (iii) about 10 weight percent of a first hydroxy-containing compound comprising a micronized phenoxy resin having a number average molecular weight of from about 10,000 to about 16,000 and a hydroxy equivalent weight of about 284, and about 10 weight percent of a second hydroxy-containing compound comprising a polyol adduct of glycol and propylene oxide having a number average molecular weight of about 700 and a hydroxy equivalent weight of about 38, and (iv) about 1 weight percent of one or more photoinitiators, wherein all weight percentages are based on the total weight of the mixture; and (b) at least one web of fibers at least partially embedded within the layer of adhesive material, wherein the at least one web of fibers has a basis weight of less than about 25 grams per square meter, an air permeability value of more than about 800 cfm/ft² (4.06 m³/m²/sec) as measured by ASTM D737-75 or ASTM D737-80, a light permeability value of more than about 75% as measured by Light Permeability Test LPT, and comprises polyester fibers having an average fiber diameter of less than about 7 microns.

In yet a further embodiment of the present invention, the structural bonding tape comprises a structural adhesive layer, which is activatable upon exposure to actinic radiation, and comprises (a) a layer of adhesive material, wherein the adhesive material is a mixture of (i) about 30 to about 60 weight percent of one or more epoxy resins, (ii) about 40 to about 30 weight percent of one or more ethyl vinyl acetate resins, (iii) about 20 to about 9 weight percent of one or more hydroxy-containing compounds, (iv) up to about 2 weight percent of one or more photoinitiators, and (v) up to about 10 weight percent of one or more additives, wherein all weight percentages are based on the total weight of the mixture; and (b) at least one web of fibers at least partially embedded within the layer of adhesive material, wherein the at least one web of fibers comprises a fiber reinforcement as described above.

In a further embodiment of the present invention, the structural bonding tape comprises a structural adhesive layer, which is activatable upon exposure to actinic radiation, and comprises (a) a layer of adhesive material, wherein the adhesive material is a mixture of (i) about 27 weight percent of a first epoxy resin having an epoxy equivalent weight of about 185 to about 192, and about 22 weight percent of a second epoxy resin having an epoxy equivalent weight of about 525 to about 550, (ii) about 30 weight percent of an ethyl vinyl acetate resin, wherein the ethyl vinyl acetate resin comprises about 70 weight percent vinyl acetate, (iii) about 10 weight percent of a first hydroxy-containing compound comprising a micronized phenoxy resin having a number average molecular weight of from about 10,000 to about 16,000 and a hydroxy equivalent weight of about 284, and about 10 weight percent of a second hydroxy-containing compound comprising a polyol adduct of glycol and propylene oxide having a number average molecular weight of about 700 and a hydroxy equivalent weight of about 38, and (iv) about 1 weight percent of one or more photoinitiators, wherein all weight percentages are based on the total weight of the mixture; and (b) at least one web of fibers at least partially embedded within the layer of adhesive material, wherein the at least one web of fibers has a basis weight of less than about 10 grams per square meter, an air permeability value of more than about 1200 cfm/ft² (6.09 m³/m²/sec) as measured by ASTM D737-75 or ASTM D737-80, a light permeability value of more than about 90% as measured by Light Permeability Test LPT, and comprises nylon fibers having a trilobal cross-sectional shape and an average fiber diameter of less than about 20 microns.

In yet a further embodiment of the present invention, the structural bonding tape comprises a structural adhesive layer, which is activatable upon exposure to actinic radiation, and comprises (a) a layer of adhesive material, wherein the adhesive material is a mixture of (i) about 20 to about 80 weight percent of one or more epoxy resins, (ii) about 40 to about 30 weight percent of one or more acrylate resins, (iii) about 20 to about 9 weight percent of one or more hydroxy-containing compounds, (iv) up to about 3 weight percent of one or more photoinitiators, and (v) up to about 10 weight percent of one or more additives, wherein all weight percentages are based on the total weight of the mixture; and (b) at least one web of fibers at least partially embedded within the layer of adhesive material, wherein the at least one web of fibers comprises a fiber reinforcement as described above.

In yet a further embodiment of the present invention, the structural bonding tape comprises a structural adhesive layer, which is activatable upon exposure to actinic radiation, and comprises (a) a layer of adhesive material, wherein the adhesive material is a mixture of (i) about 53.9 weight percent of a first epoxy resin having an epoxy equivalent weight of about 185 to about 192, and about 9.8 weight percent of a second epoxy resin having an epoxy equivalent weight of about 525 to about 550, (ii) about 30 weight percent of a (meth)acrylate resin, wherein the (meth)acrylate resin comprises a poly(meth)acrylate elastomer having an ethylene, propylene or butylene repeating unit, wherein the ethylene, propylene or butylene repeating unit molar ratio to (meth)acrylate repeating units is less than about 2, (iii) about 4.3 weight percent of a hydroxy-containing compound comprising a polyol adduct of glycol and propylene oxide having a number average molecular weight of about 700 and a hydroxy equivalent weight of about 38, and (iv) about 2 weight percent of one or more photoinitiators, wherein all weight percentages are based on the total weight of the mixture; and (b) at least one web of fibers at least partially embedded within the layer of adhesive material, wherein the at least one web of fibers has a basis weight of less than about 25 grams per square meter, an air permeability value of more than about 1300 cfm/ft² (6.59 m³/m²/sec) as measured by ASTM D737-75 or ASTM D737-80, a light permeability value of more than about 75% as measured by Light Permeability Test LPT, and comprises polyester fibers having a round cross-sectional shape and an average fiber diameter of less than about 20 microns.

In any of the above-described structural bonding tapes, the at least one web of fibers may be completely embedded within outer surfaces of the structural adhesive layer of the structural bonding tape. In addition, any of the above-described structural bonding tapes may further comprise at least one additional layer, wherein the at least one additional layer comprises a release liner, a non-structural adhesive layer, a non-adhesive film, a foil, a paper, a foam, a woven fabric, a nonwoven fabric, a knitted fabric, or a combination thereof. The structural bonding tapes may be in the form of a roll of tape containing any of the above-described structural adhesive layers and one or more additional layers.

Methods of making Structural Bonding Tapes

The structural bonding tapes of the present invention may be prepared in a number of ways. For example, the components of the structural adhesive layer adhesive composition may be combined and mixed in a suitable mixing vessel at an elevated temperature low enough to avoid decomposition of any photoinitiator present in the adhesive composition. Although mix times may vary, the components of the structural adhesive layer adhesive composition are desirably mixed for a period of time sufficient to form a uniform mixture of components. After mixing, the structural adhesive layer adhesive composition may be formed into its final shape by a variety of different methods. For example, the structural adhesive layer adhesive composition may be coated onto a release liner to form a layer using a heated knife coater. Alternatively, the components of the structural adhesive layer adhesive composition may be compounded in an extruder and then extruded through a die having a desired profile to produce a shaped strip of adhesive; that is, a strip having a desired cross-sectional shape. In a further approach, the structural adhesive layer adhesive composition may be extruded as a mass and delivered between a pair of motor-driven chilled rolls spaced apart a predetermined distance to form a flat sheet of the structural adhesive layer adhesive composition that may be subsequently calendared to a desired thickness.

In a batch process, the structural adhesive layer adhesive composition of the structural bonding tape of the present invention is prepared by mixing the various ingredients in one or more suitable vessels, desirably vessels that are not transparent to actinic radiation. The liquid components, such as liquid epoxies and hydroxyl-containing materials, may be premixed in a first vessel at a temperature of up to about 90° C., while the thermoplastic and solid epoxy components mix in a separate vessel at an elevated temperature of up to about 110° C. sufficient to liquefy the components. The liquid components may then be added to the melted thermoplastic and epoxy components and mixed with stirring until the components are thoroughly melt blended without thermally degrading or causing premature curing of the materials. The components may be added simultaneously or sequentially in any order; however, it is desirable to add the photoinitiator after all of the other components have thoroughly mixed.

In a continuous process, the structural adhesive layer adhesive composition of the present invention is mixed in an extruder as above, for example a twin screw extruder, equipped with a down stream port, a static mixer, and an appropriate output orifice (i.e., film die, sheet die, profile die, etc.) and a take-up roll and wind up roll(s), as appropriate. Take-up line speed may be adjusted as appropriate for the output form.

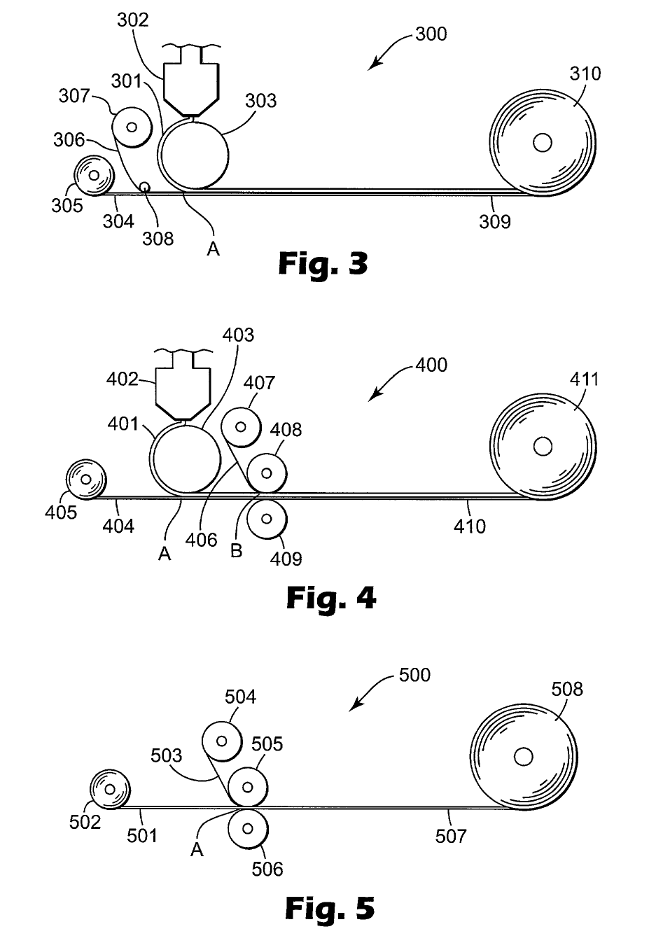

One or more fiber reinforcements may be combined with the structural adhesive layer adhesive composition by a variety of methods. FIGS. 3 to 5 display various methods of combining one or more fiber reinforcements with the structural adhesive layer adhesive composition of the structural bonding tape. In FIG. 3, process 300 is shown, wherein structural adhesive layer adhesive composition 301 is extruded from vessel 302 onto roll 303. Release liner 304 is unrolled from roll 305 to form a support surface for structural adhesive layer adhesive composition 301 and fiber reinforcement 306, which is unrolled from roll 307. A nip 308 may be used to position fiber reinforcement 306 adjacent to release liner 304. At point A, structural adhesive layer adhesive composition 301 is brought into contact with fiber reinforcement 306 on release liner 304. Roll 303 applies a desired amount of pressure to coat and/or encapsulate fiber reinforcement 306. The resulting structural bonding tape 309 may be taken up on take up roll 310.

In a further embodiment of the present invention, a second exemplary method of combining a fiber reinforcement with a structural adhesive layer adhesive composition is disclosed as shown in FIG. 4. In FIG. 4, process 400 is shown, wherein structural adhesive layer adhesive composition 401 is extruded from vessel 402 onto roll 403. Release liner 404 is unrolled from roll 405 to form a support surface for structural adhesive layer adhesive composition 401 as structural adhesive layer adhesive composition 401 contacts release liner 404 at point A. Fiber reinforcement 406 is unrolled from roll 407 and brought into contact with structural adhesive layer adhesive composition 401 at point B between nips 408 and 409. Nips 408 and 409 apply a desired amount of pressure to force fiber reinforcement 406 onto and/or into structural adhesive layer adhesive composition 401. The resulting structural bonding tape 410 may be taken up on take up roll 411.

In yet a further embodiment of the present invention, a third exemplary method of combining a fiber reinforcement with a structural adhesive layer adhesive composition is disclosed as shown in FIG. 5. In FIG. 5, process 500 is shown, wherein a pre-assembled, pre-lined structural adhesive layer adhesive composition/release liner combination 501 is unrolled from roll 502. Fiber reinforcement 503 is unrolled from roll 504 and brought into contact with structural adhesive layer adhesive composition/release liner combination 501 at point A between nips 505 and 506. Nips 505 and 506 apply a desired amount of pressure to force fiber reinforcement 503 onto and/or into structural adhesive layer adhesive composition/release liner combination 501. The resulting structural bonding tape 507 may be taken up on take up roll 508.

In all of the above-described methods of manufacture, it is desirable to use an actinic radiation blocking release liner in combination with the uncured structural adhesive layer to protect the exposed surfaces of the uncured structural adhesive layer from premature exposure to actinic radiation. Further, it is also desirable to protect the resulting structural bonding tape from premature activation, for example, during storage and shipping. This may be accomplished, for example, by storing the structural bonding tape in an actinic radiation blocking container.

In one embodiment of the present invention, a structural adhesive layer is made by forming a mixture comprising: (i) about 20 to about 80 weight percent of one or more epoxy resins, (ii) about 50 to about 20 weight percent of one or more resins selected from polyester resins, ethyl vinyl acetate resins, and (meth)acrylate resins, (iii) up to about 30 weight percent of one or more hydroxy-containing compounds; (iv) up to about 5 weight percent of one or more photoinitiators, and (v) up to about 50 weight percent of one or more additives, wherein all weight percentages are based on a total weight of the mixture; applying a sheet of the mixture to a substrate; and contacting the sheet with at least one web of fibers so that the at least one web of fibers is at least partially embedded in the sheet, wherein the at least one web of fibers has a basis weight of less than about 30 grams per square meter, an air permeability value of more than about 600 cfm/ft² (3.04 m³/m²/sec) as measured by ASTM D737-75 or ASTM D737-80, a light permeability value of more than about 10% as measured by Light Permeability Test LPT, and comprises fibers having an average fiber diameter of less than about 20 microns. The method may further comprises positioning at least one additional layer on an exposed surface of the structural adhesive layer, wherein the at least one additional layer comprises a release liner, a non-structural adhesive layer, a non-adhesive film, a foil, a paper, a foam, a woven fabric, a nonwoven fabric, a knitted fabric, or a combination thereof.

Methods of using Structural Bonding Tapes

The structural bonding tapes of the present invention may be used in a variety of applications. In one embodiment of the present invention, the structural bonding tape is used to bond two similar or different substrates to one another. The structural bonding tapes of the present invention may be used to bond together a variety of substrates. Suitable substrates, which may be bonded together using the structural bonding tape of the present invention, include, but are not limited to, plastics, metals, ceramics, glass, cellulosic materials, elastomeric substrates such as rubber, composite materials such as fiber-reinforced plastics (FRP), wood-containing materials, and combinations thereof.

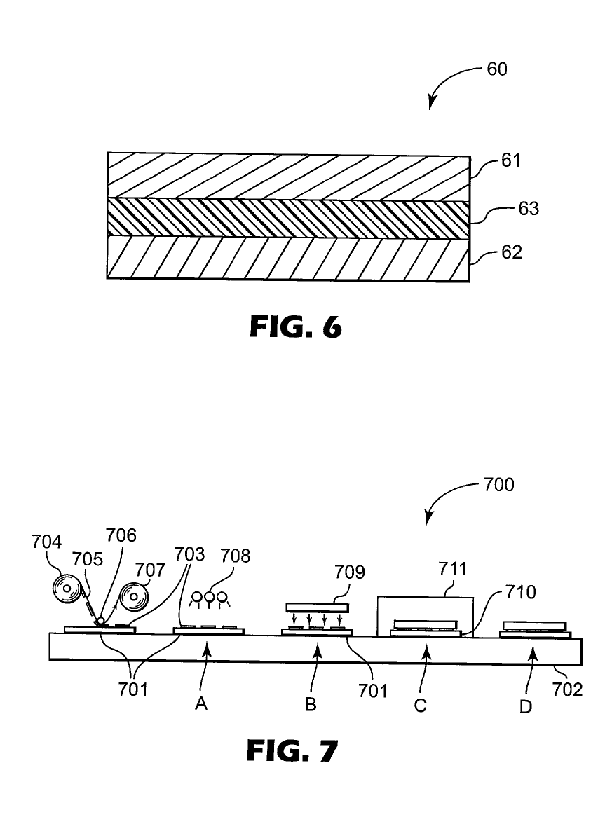

An exemplary bonded article is shown in FIG. 6, wherein the bonded article 60 comprises first substrate 61 bonded to second substrate 62 via structural bonding tape 63 positioned between first substrate 61 and second substrate 62.

Typically, the structural bonding tape of the present invention is brought into contact with a first substrate. The exposed surface of the structural bonding tape is then exposed to actinic radiation to initiate curing of (i.e., activate) the structural adhesive layer of the structural bonding tape. A second substrate is then brought into contact with the exposed surface of the structural bonding tape. A desired amount of pressure may be applied to insure maximum surface contact between the substrates and the structural bonding tape. Alternatively, the structural bonding tape may be irradiated, and then bonded to a first substrate, and subsequently or simultaneously to a second substrate. In a further alternative, the structural bonding tape may be bonded to a first substrate, and subsequently or simultaneously to a second substrate, and then irradiated as long as one of the substrates is transparent so that the radiation can activate the structural adhesive layer of the structural bonding tape.

The structural adhesive layer of the structural bonding tape may be activated by exposing the structural adhesive layer to a light source, which emits actinic radiation. Suitable sources of radiation include, but are not limited to, mercury lamps, xenon lamps, carbon arc lamps, tungsten filament lamps, sunlight, etc. Although the focus of the present invention is directed to activating by actinic radiation, it should be noted that other means of activation may be used in the present invention including, but not limited to, e-beam, and gamma radiation;

however, activation by actinic radiation is desired. More desirably, the structural adhesive layer of the structural bonding tape is activated by exposing the structural adhesive layer to a light source, which emits radiation having a wavelength of from about 200 nm to about 500 nm. Even more desirably, the structural adhesive layer of the structural bonding tape is activated by exposing the structural adhesive layer to a light source, which emits radiation having a wavelength of from about 300 nm to about 470 nm. Even more desirably, the structural adhesive layer of the structural bonding tape is activated by exposing the structural adhesive layer to a light source, which emits radiation having a wavelength of from about 310 nm to about 380 nm. In one embodiment of the present invention, the radiation source is desirably a medium pressure mercury arc lamp.

Exposure times may be from less than about 1 second to about 10 minutes or more to provide a total energy exposure of from about 0.5 Joules/square centimeter (J/cm²) to about 4.0 Joules/square centimeter (J/cm²) depending upon both the amount and the type of reactants involved, the radiation source, the distance from the radiation source, and the thickness of the structural adhesive layer to be activated. The rate of activation tends to increase with increasing amounts of photoinitiator at a given light exposure or irradiation. The rate of activation also increases with increased radiation intensity. Desirably, exposure times are from less than about 1 second to about 3 seconds to provide a total energy exposure of from about 1.0 J/cm² to about 3.8 J/cm². More desirably, exposure times are less than about 1 second to provide a total energy exposure of from about 1.35 J/cm² to about 1.80 J/cm².

Once the structural adhesive layer of the structural bonding tape is exposed to radiation, the curing process is initiated. Subsequent to radiation exposure, the structural adhesive layer may be tack-free, or may be tacky for a limited period of time, but eventually achieves a tack-free condition. Full cure may be achieved under ambient conditions in about 7 days or as little as about 8 to about 16 hours, depending upon the intensity of the radiation source, the radiation exposure time, the concentration of the photoinitiator, and the particular ingredients, which comprise the structural adhesive layer adhesive composition. The time to reach full cure may be accelerated by post curing the structural adhesive layer with heat, such as in an oven. The time and temperature of the post cure may vary depending upon the concentration and type of the photoinitiator, the radiation exposure conditions, and the like. Typical post cure conditions for onium salt type catalysts range from 5 to 15 minutes at between about 50° C. and about 85° C., to about 1 to 5 minutes at temperatures up to about 100° C. A typical post cure condition for cationic organometallic catalysts is from about 15-35 minutes at a temperature of about 177° C. An accelerated cure may also be achieved by applying heat and pressure to bond two substrates together such as when using a heated press, a heated laminator or heated nip rollers; however it should be noted that heat is not necessary to cure the structural adhesive layer of the structural bonding tapes of the present invention.

In some cases, it may be advantageous to retard the cure rate of the structural adhesive layer of the structural bonding tape. For example, structural adhesive layer compositions that contain a polyether polyol, typically have a slower cure rate, which is particularly desirable when bonding together two substrates that are not transparent to the radiation. After applying the structural bonding tape to the first substrate and irradiating the structural bonding tape, the second substrate may be bonded to the first substrate for a certain period of time (for example, from about 2 minutes to about 4 hours) until the structural bonding tape has sufficiently cured that a useful bond can no longer be made. Thus, it will be recognized that the presence of the polyether polyol provides the structural adhesivelayer composition of the structural bonding tape with an open time. That is, for a period of time (i.e., the open time) after the structural bonding tape has been irradiated, it remains sufficiently uncured for a second substrate to be bonded thereto.

The second substrate may typically be bonded to an exposed surface of the structural bonding tape using pressure, optional heat, or both pressure and heat, (for example, with a heated press, heated nip rollers, or a heated laminator). Depending on the particular structural lo adhesive layer adhesive composition, the conditions for applying the second substrate may range from a few seconds at room temperature to about 15 seconds at about 170° C. Desirably, the conditions for applying the second substrate ranges from a few seconds to about 10 seconds at room temperature. Laminator pressures of about 274 kiloPascals (kPa) may be useful in some cases.

In one desired embodiment of the present invention, bonded articles are prepared by a continuous process as shown in FIG. 7. In process 700 as shown in FIG. 7, a first substrate 701 is transported along transport belt 702 and brought into contact with die cut structural bonding tapes 703, applied from an applicator 704, which comprises release film 705, applicator nip 706, and take up roll 707 for the tape-less release film 705. First substrate 701 with die cut structural bonding tapes 703 proceeds along belt 702 to point A under radiation source 708, exposing first substrate 701 and die cut structural bonding tapes 703 to an amount of radiation sufficient to initiate cure of the die cut structural bonding tapes 703. First substrate 701 with activated die cut structural bonding tapes 703 proceeds along belt 702 to point B, where second substrate 709 is brought into contact with activated die cut structural bonding tapes 703 to form a bonded article 710. Bonded article 710 proceeds along belt 702 to point C, where an optional heating chamber 711 accelerates curing of the die cut structural bonding tapes 703. Cured bonded article 710 proceeds along belt 702 to point D, where the article can be removed from belt 702 for further processing or packaged as desired.

A number of variations may be made to the above-described process of making bonded articles to achieve desirable results. For example, in one embodiment of the present invention, the fiber reinforcement of the structural adhesive layer of the structural bonding tape may be dyed to impart a color to the fiber reinforcement. In one case, a polyester REEMAY™ 2275 scrim (Reemay, Inc., Old Hickory, Tenn.) may be dyed black to give a black appearance to the structural bonding tape. Due to the gaps between the fibers of this non-woven scrim, the structural bonding tape receives a dose of UV radiation and fully cures without requiring a more lengthy UV exposure.

In a further embodiment of the present invention, a mutable dye may be added to the structural adhesive layer so that a color change results in response to actinic radiation exposure. The mutable dye acts as a radiation exposure indicator. The mutable dye may be used to dye the fiber reinforcement or may be incorporated into the structural adhesive composition. In one case, a polyester REEMAY™ 2275 scrim (Reemay, Inc., Old Hickory, Tenn.) may be dyed using ordinary food coloring. Upon exposure to actinic radiation, the dyed REEMAY™ 2275 scrim (Reemay, Inc., Old Hickory, Tenn.) becomes colorless (i.e., the mutable dyes bleach).

Specific Bonded Articles

The present invention is directed to a variety of bonded articles formed by two similar or different substrates and a structural bonding tape. A number of particularly desirable bonded articles include, but are not limited to, plastics bonded to aluminum; plastics bonded to ceramics; metals, such as aluminum and steel, bonded to one another; and glass bonded to a metal.

In one embodiment of the present invention, the bonded article comprises a first substrate; a second substrate; and a structural adhesive layer positioned between the first substrate and the second substrate, wherein the structural adhesive layer comprises (a) a layer of adhesive material, wherein the adhesive material is a mixture of (i) about 20 to about 80 weight percent of one or more epoxy resins, (ii) about 50 to about 20 weight percent of one or more resins selected from polyester resins, ethyl vinyl acetate resins, and (meth)acrylate resins, (iii) up to about 30 weight percent of one or more hydroxy-containing compounds, (iv) up to about 5 weight percent of one or more photoinitiators, and (v) up to about 50 weight percent of one or more additives, wherein all weight percentages are based on a total weight of the mixture; and (b) at least one web of fibers at least partially embedded within the layer of adhesive material, wherein the at least one web of fibers has a basis weight of less than about 30 grams per square meter, an air permeability value of more than about 600 cfm/ft² (3.04 m³/m²/sec) as measured by ASTM D737-75 or ASTM D737-80, a light permeability value of more than about 10% as measured by Light Permeability Test LPT, and comprises fibers having an average fiber diameter of less than about 20 microns. The structural adhesive layer may be activated upon exposure to actinic radiation and fully cured with or without heat to form a cured bonded article.

In another embodiment of the present invention, the bonded article comprises a first substrate; a second substrate; and a structural adhesive layer positioned between the first substrate and the second substrate, wherein the structural adhesive layer comprises (a) a layer of adhesive material, wherein the adhesive material is a mixture of (i) about 27 weight percent of a first epoxy resin having an epoxy equivalent weight of about 185 to about 192, and about 22 weight percent of a second epoxy resin having an epoxy equivalent weight of about 525 to about 550, (ii) about 30 weight percent of a polyester resin, wherein the polyester resin is an amorphous branched copolyester having a glass transition temperature of less than about −5° C., (iii) about 10 weight percent of a first hydroxy-containing compound comprising a micronized phenoxy resin having a number average molecular weight of from about 10,000 to about 16,000 and a hydroxy equivalent weight of about 284, and about 10 weight percent of a second hydroxy-containing compound comprising a polyol adduct of glycol and propylene oxide having a number average molecular weight of about 700 and a hydroxy equivalent weight of about 38, and (iv) about 1 weight percent of one or more photoinitiators, wherein all weight percentages are based on the total weight of the mixture; and (b) at least one web of fibers at least partially embedded within the layer of adhesive material, wherein the at least one web of fibers has a basis weight of less than about 25 grams per square meter, an air permeability value of more than about 800 cfm/ft² (4.06 m³/m²/sec) as measured by ASTM D737-75 or ASTM D737-80, a light permeability value of more than about 75% as measured by Light Permeability Test LPT, and comprises polyester fibers having an average fiber diameter of less than about 7 microns. The structural adhesive layer may be activated upon exposure to actinic radiation and fully cured with or without heat to form a cured bonded article.

In a further embodiment of the present invention, the bonded article comprises a first substrate; a second substrate; and a structural adhesive layer positioned between the first substrate and the second substrate, wherein the structural adhesive layer comprises (a) a layer of adhesive material, wherein the adhesive material is a mixture of (i) about 27 weight percent of a first epoxy resin having an epoxy equivalent weight of about 185 to about 192, and about 22 weight percent of a second epoxy resin having an epoxy equivalent weight of about 525 to about 550, (ii) about 30 weight percent of an ethyl vinyl acetate resin, wherein the ethyl vinyl acetate resin comprises about 70 weight percent vinyl acetate (iii) about 10 weight percent of a first hydroxy-containing compound comprising a micronized phenoxy resin having a number average molecular weight of from about 10,000 to about 16,000 and a hydroxy equivalent weight of about 284, and about 10 weight percent of a second hydroxy-containing compound comprising a polyol adduct of glycol and propylene oxide having a number average molecular weight of about 700 and a hydroxy equivalent weight of about 38, and (iv) about 1 weight percent of one or more photoinitiators, wherein all weight percentages are based on the total weight of the mixture; and (b) at least one web of fibers at least partially embedded within the layer of adhesive material, wherein the at least one web of fibers has a basis weight of less than about 10 grams per square meter, an air permeability value of more than about 1200 cfm/ft² (6.09 m³/m²/sec) as measured by ASTM D737-75 or ASTM D737-80, a light permeability value of more than about 90% as measured by Light Permeability Test LPT, and comprises nylon fibers having a trilobal cross-sectional shape and an average fiber diameter of less than about 20 microns. The structural adhesive layer may be activated upon exposure to actinic radiation and fully cured with or without heat to form a cured bonded article.

In yet a further embodiment of the present invention, the bonded article comprises a first substrate; a second substrate; and a structural adhesive layer positioned between the first substrate and the second substrate, wherein the structural adhesive layer comprises (a) a layer of adhesive material, wherein the adhesive material is a mixture of (i) about 53.9 weight percent of a first epoxy resin having an epoxy equivalent weight of about 185 to about 192, and about 9.8 weight percent of a second epoxy resin having an epoxy equivalent weight of about 525 to about 550, (ii) about 30 weight percent of a (meth)acrylate resin, wherein the (meth)acrylate resin comprises a poly(meth)acrylate elastomer having an ethylene, propylene or butylene repeating unit, wherein the ethylene, propylene or butylene repeating unit molar ratio to (meth)acrylate repeating units is less than about 2, (iii) about 4.3 weight percent of a hydroxy-containing compound comprising a polyol adduct of glycol and propylene oxide having a number average molecular weight of about 700 and a hydroxy equivalent weight of about 38, and (iv) about 2 weight percent of one or more photoinitiator,; wherein all weight percentages are based on the total weight of the mixture; and (b) at least one web of fibers at least partially embedded within the layer of adhesive material, wherein the at least one web of fibers has a basis weight of less than about 25 grams per square meter, an air permeability value of more than about 1300 cfm/ft² (6.59 m³/m²/sec) as measured by ASTM D737-75 or ASTM D737-80, a light permeability value of more than about 75% as measured by Light Permeability Test LPT, and comprises polyester fibers having a round cross-sectional shape and having an average fiber diameter of less than about 20 microns. The structural adhesive layer may be activated upon exposure to actinic radiation and fully cured with or without heat to form a cured bonded article.

In any of the above-described bonded articles, the first substrate may comprise plastic, metal, ceramic, glass, cellulosic, elastomeric, rubber, wood materials, or a combination thereof; the second substrate may comprise plastic, metal, ceramic, glass, cellulosic, elastomeric, rubber, wood materials, or a combination thereof; and the first substrate may be similar or different from the second substrate. In some desired embodiments of the present invention, the first substrate is different from the second substrate.

The bonded articles of the present invention find utility in a number of applications including, but not limited to, use as heat sinks in electronic components.

The present invention is described above and further illustrated below by way of examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### TEST METHODS

The following test methods were used to measure physical properties of exemplary uncured and cured structural bonding tapes of the present invention.

Test Methods for Fiber Reinforcements

Air Permeability

Air permeability is a measure of the ease with which air passes through a layer of test material. It is measured in cubic feet of air passing through a square foot of test material in one minute at a given pressure differential across the test material.

Air permeability values for the samples of fiber reinforcements used in the present invention were obtained from the manufacturer as tested according to Test Method ASTM D737-75, ASTM D737-80, or as otherwise stated.

UV Light Permeability Test LPT

A layer of fiber reinforcement sample to be tested was placed on a sample holder and positioned over an array of SYLVANIA™ 350 blacklights available from Sylvania (Danver, Mass.). Light intensity was measured when no sample was present in the sample holder (Iᵢₙᵢₜᵢₐₗ). The sample holder was used to position the test sample directly over the sensor of a radiometer sensitive to the UVA bandwidth. The radiometer used was a UVIRAD™ manufactured by EIT, Sterling, Va. The test sample was then put into the holder and the light intensity was measured (I_{final}) UV light permeability was then calculated using the equation:

% UV light permeability=(I_{final}/Iᵢₙᵢₜᵢₐₗ)×100

An average value was determined from 3 measurements, each measurement being taken from a different piece of test sample.

Test Methods for the Uncured Structural Bonding Tapes

In the following test methods, all samples of structural bonding tape were conditioned at 23° C. and 10% humidity for 24 hours prior to testing.

Cold Flow

A one inch (2.54 cm) diameter (Dᵢₙᵢₜᵢₐₗ) piece of uncured tape to be tested was placed on a sheet of siliconized liner, covered with a sheet of siliconized liner, and a two pound (0.9 kg) weight was positioned on the sheet of siliconized liner over the piece of uncured tape. After 72 hours dwell at room temperature (about 23° C.), the diameter (D_{final}) of the test tape was measured and the percent (%) change in flow calculated using the following formula:

% Flow=(D_{final}/Dᵢₙᵢₜᵢₐₗ)×100

In addition, D_{final} for the test tape was compared to D_{final} for its Comparative Example (i.e. the test tape without fiber reinforcement) and the % difference was calculated as follows:

$$\% change = \frac{{D}_{final} ( Comparative Ex . ) - {D}_{final} ( Test tape )}{{D}_{final} ( Comparative Ex . )} \times 100$$

Peel Adhesion (90°)

A stainless steel plate measuring 2 inches×5 inches (5.1 cm×12.7 cm) was cleaned by wiping once with acetone, then three times with heptane, and allowed to air dry.

One liner was removed from a test specimen measuring 5 inches×0.5 inch (12.7 cm×1.27 cm). The exposed adhesive face was applied to the steel plate and pressed on lightly by hand. The second liner was then removed and a 0.625 inch (1.59 cm) wide×8-10 inches (20.3-25.4 cm) long×0.005 inch (127 microns) thick strip of aluminum foil (one side anodized) was placed over the adhesive face with the anodized side contacting the adhesive. The aluminum foil covering was then rolled down onto the tape specimen twice using a mechanically driven metal roller having a weight of 15 lb (6.8 kg).

After a dwell time of 20 minutes at room temperature, the 90° Peel Adhesion Test was performed using an INSTRON™ Tensile Tester Model 4465 fitted with a 90° peel test apparatus and available from Instron Corp., Canton, Mass., at a peel speed of 12 inches/minute (30.5 cm/min).

Each material was evaluated three times and the results averaged. The peel force for the first and last inch of the test specimen as well as any areas severely affected by sample preparation or poor contact was discarded. Test data was recorded in units of pounds per inch width (piw) and converted to newtons/millimeter (N/mm).

Test Methods for the Cured Structural Bonding Tapes

Overlap Shear Strength

Aluminum coupons (4 inches×1 inch×0.0625 inch (10.16 cm×2.54 cm×0.159 cm)) were subjected to light abrasion with a wire brush followed by wiping with a 50% by weight isopropanol in water solution.

The assemblies were prepared by removing one of the protective liners from the strip tape measuring 0.5 inch×1 inch (1.27 cm×2.54 cm) as prepared according to the general preparations of adhesive sheets or the General Preparation of Fiber Reinforcement Containing Adhesive Sheet described herein below. The exposed adhesive face was then applied to the surface of one aluminum coupon by hand with light thumb pressure. The second protective liner was then removed. The exposed adhesive face was then irradiated with an amount of UV-A radiation (as reported in the tables below) emitted from a UV lamp available as Fusion UV Curing System HP6B-6 (Fusion UV Systems, Inc., Gaithersburg, Md.) equipped with a D-bulb. The amount of energy used to irradiate the adhesive face was measured using a UVI MAP™ UV and Temperature Measuring/Plotting System, Model UM365H-S (Electronic Instrumentation Technology Inc., Sterling, Va.) designated to measure UV-A radiation in the range of 320-390 nm. The device was calibrated according to NIST (National Institute of Standards and Technology) Standards.

Immediately after the UV irradiation process, the second aluminum test coupon was applied to the irradiated adhesive face in such a fashion as to prepare a bond having an overlap area of one square inch (6.45 cm²) suitable for overlap shear testing.

The bonded assemblies were placed in a platen press and subjected to a force of 40 lbs/in² (0.276 MPa) for 5 sec. The assemblies were then heated in an oven at 85° C. for 30 minutes and allowed to cool at 23° C. for about 1 hour before testing the cured assemblies.

In an alternative pressing step, the bonded assemblies were placed in a platen press and subjected to a force of 40 lbs/in² (0.276 MPa) for 5 sec. The assemblies were then allowed to cure at 23° C. for 7 days (i.e., no heating) before testing the cured assemblies.

A dynamic overlap shear test was performed at 23° C. on the cured assemblies prepared as described above using a SINTECH™ 5/GL tester (SINTECH™ Inc., Stoughton, Mass.). The cross-head speed was 0.1 inch/minute (0.254 cm/min). The test was repeated three times for each sample and the average value recorded in pounds and converted to pounds per square inch (psi) and to megaPascals (MPa).

The test was also performed at elevated temperature (65° C.) by placing the bonded sample assembly and the jaws of the tensile tester in a forced air oven especially designed to function in conjunction with tensile testing equipment.

Impact Test

The impact test was performed according to ASTM (American Society of Testing and Materials, Philadelphia, Pa.) D 950-82 using two bonding substrates having the following description:

Substrate 1—1 inch×1.44 inch×0.75 inch (2.54 cm×3.65 cm×1.9 cm) aluminum block, and

Substrate 2—1 inch diameter×0.375 inch (2.54 cm×0.95 cm) aluminum disc.

A bonding area of 0.79 square inch (5.10 cm²) was employed.

A sample of uncured tape having approximately the same dimensions as Substrate 2 was applied to Substrate 2 and pressed on lightly by hand. Then the liner was removed and the exposed adhesive side was then irradiated with an amountof UV-A radiation (as reported in the tables below) using the equipment described in the Overlap Shear Test above.

Substrate 1 was then immediately applied to the irradiated adhesive side, in such a fashion, as to prepare a bond suitable for impact testing. The bonded assemblies were placed in a platen press at 23° C. and subjected to a force of 40 lbs/in² (0.276 MPa) for 5 sec. Then, the bonded assemblies were cured at about 23° C. for 7 days or in an oven at 85° C. for 30 minutes. The bonded assemblies were then tested at −20° C. or at room temperature (about 23° C.).

The determination of impact value was carried out with an impact tester (available as Impact Tester Model 43-02 from Testing Machine Inc., Islandia, N.Y.), where an Izod pendulum having a 20 ft-lbf/in² (42.04 kJ/m²) energy impacted Substrate 2 while Substrate 1 was held stationary. The pendulum was directed at the test construction in such a way as to exert a shearing force on the adhesive bond. Three specimens were tested at 23° C. and the average data in ft-lbf/in² were recorded and then converted to kJ/m².

The test was also performed at cold temperatures (−20° C.) by placing the bonded sample assembly in a cold box especially designed to function in conjunction with tensile testing equipment.

Floating Roller Peel

The floating roller peel was performed according to ASTM D3167-93.

Etched aluminum coupons were prepared as follows:

Coupon 1—Alcoa 2024 T3 aluminum alloy (Alcoa Aluminum Co., Catawba, N.C.), 0.025 inch (0.0635 cm) thick, Forest Products Laboratory (FPL) etched no more than 8 hours prior to bonding.

Coupon 2 (backing)—Alcoa 2024 T3 aluminum alloy (Alcoa Aluminum Co., Catawba, N.C.), 0.063 inch (0.160 cm) thick, FPL etched no more than 8 hours prior to bonding.

The assemblies were prepared by removing one of the protective liners from the strip tape measuring one inch×10 inches (2.54 cm×25.4 cm) as generated in the examples. The exposed adhesive face was then applied to the surface of Coupon 2 by hand with light thumb pressure. The second protective liner was then removed.

The exposed adhesive face was then irradiated with an amount of UV-A radiation (as reported in the tables below) emitted from a UV lamp available as Fusion UV Curing System HP6B-6 (Fusion UV Systems, Inc., Gaithersburg, Md.) equipped with a D-bulb. The amount of energy used to irradiate the adhesive face was measured using a UVI MAP™ UV and Temperature Measuring/Plotting System, Model UM365H-S (Electronic Instrumentation Technology Inc., Sterling, Va.) designated to measure UV-A radiation in the range of 320-390 nm. The device was calibrated according to NIST (National Institute of Standards and Technology) Standards.

Immediately after the UV irradiation process, Coupon 1 was applied to the irradiated adhesive face in such a fashion as to prepare a bond having an overlap area of 5 square inches (32.6 cm²) suitable for roller peel testing.

The bonded assemblies were placed in a platen press and subjected to a force of 2-8 lbs/sq.in. (0.0138-0.055 MPa) for approximately 5 sec. The assemblies were then heated at 85° C. for 20-30 minutes and allowed to cool at 23° C. for about 1 hour before testing the cured assemblies.

A floating roller peel test was performed at 23° C. on the cured assemblies prepared as described above using a SINTECH™ 5/GL tester (Sintech, Inc., Stoughton, Mass.) equipped with a 200 lb (90.9 kg) load cell. The cross-head speed was 6 inches/minute (15.24 cm/min). The test was repeated three times for each sample and over a peel distance of 3 inches (7.62 cm) (Total peel distance was 5 inches (12.7 cm), but the data for the first and last inch was discarded). The average value was recorded in pounds and converted to pounds per inch width (piw) and to Newtons per millimeter (N/mm).

### EXAMPLES

The following examples were conducted using the materials shown in Table 1 below.

TABLE 1
Structural Bonding Tape Materials

| Trade Designation/ | | |
|---|---|---|
| Material | Source | Description |
| Polyester | | |
| DYNAPOL ™ | Huels AG | hydroxy functional, |
| S1422 | (Creanova | amorphous branched |
| | Specialties), | copolyester, |
| | Marl, Germany | Tg = −5° C. |
| Epoxy | | |
| EPON ™ 1001F | Resolution, | solid epoxy, |
| | Houston, TX | epoxy eq. wt. 525-550 |
| EPON ™828 | Resolution, | epoxy, |
| | Houston, TX | epoxy eq. wt. 185-192 |
| EPON ™ 1004 | Resolution, | solid epoxy, |
| | Houston, TX | epoxy eq. wt. 800-950 |
| D.E.N. 438 | Dow Chemical Co., | epoxy, |
| | Midland, MI | epoxy eq. wt. 176-181 |
| Hydroxy-Containing | | |
| Compound | | |
| PAPHEN ™ | Phenoxy Associates, | micronized phenoxy |
| PKHP-200 | Rock Hill, SC | resin, Mn = 10,000- |
| | | 16,000, OH eq. wt. 284 |
| VORANOL ™ | Dow Chemical Co., | liquid polyol adduct of |
| 230-238 | Midland, MI | glycol and propylene |
| | | oxide, Mn = 700, |
| | | OH eq. wt. 38 |
| Polycaprolactone | Aldrich Chemical | viscous liquid, |
| triol | Co., Milwaukee, WI | avg. Mn 300, |
| | | soft. temp. 10° C. |
| EVA | | |
| LEVAPREN ™ | Bayer Corporation, | 70% by wt. vinyl acetate, |
| 700HV | Pittsburgh, PA | Mooney viscosity 27 |
| | | [ASTM D 1646] |
| Acrylate | | |
| HYTEMP ™ | Zeon Chemicals Co. | polyacrylate elastomer, |
| 4051EP | Inc, Louisville, KY | Mooney viscosity 35-50 |
| Cationic | | |
| Photoinitiator | | |
| UVOX ™ | Union Carbide, | triarylsulfonium |
| UVI 6974 | Danbury, CT | complex salt |
| Additive | | |
| ZEON ™ | Zeon Chemicals Co. | Acrylic core shell |
| F-351 | Inc, Louisville, KY | impact modifier |
| Fiber | | |
| Reinforcement | | |
| REEMAY ™ 2250 | Reemay, Inc., | Spunbonded polyester, |
| | Old Hickory, TN | round cross-section, |
| | | straight fibers, |
| | | basis wt. 17 g/m² |
| REEMAY ™ 2275 | Reemay, Inc., | Spunbonded polyester, |
| | Old Hickory, TN | round cross-section, |
| | | straight fibers, |
| | | basis wt. 25 g/m² |
| TFP 20202A/8 | Technical Fibre | Polyester, |
| | Products, UK | basis wt. 8 g/m² |
| TFP 20202A/12 | Technical Fibre | Polyester, |
| | Products, UK | basis wt. 12 g/m² |
| TFP 20202A/17 | Technical Fibre | Polyester, |
| | Products, UK | basis wt. 17 g/m² |
| TFP 20204A | Technical Fibre | Polyester, |
| | Products, UK | basis wt. 25 g/m² |
| TFP 20216 | Technical Fibre | Polyester, |
| | Products, UK | basis wt. 27 g/m² |
| TFP A1-7-2 | Technical Fibre | Polyester Microdenier, |
| | Products, UK | basis wt. 8 g/m² |
| TFP | Technical Fibre | Polyester Microdenier, |
| Microdenier | Products, UK | basis wt. 12 g/m² |
| TFP A1-2-10 | Technical Fibre | Microdenier, |
| | Products, UK | basis wt. 25 g/m² |
| TFP 20404A | Technical Fibre | NCG tissue, |
| | Products, UK | basis wt. 8 g/m² |
| TFP 206012A | Technical Fibre | Aramid fiber, |
| | Products, UK | basis wt. 13 g/m² |
| TFP 20103A/5.5 | Technical Fibre | Glass fiber, |
| | Products, UK | basis wt. 5.5 g/m² |
| TFP 20103A/10 | Technical Fibre | Glass fiber, |
| | Products, UK | basis wt. 10 g/m² |
| TFP 20103A/17 | Technical Fibre | Glass fiber, |
| | Products, UK | basis wt. 17 g/m² |
| TFP 20103A/30 | Technical Fibre | Glass fiber, |
| | Products, UK | basis wt. 30 g/m² |
| TFP 20107A | Technical Fibre | Antistatic fiber, |
| | Products, UK | basis wt. 20 g/m² |
| TFP 20301 | Technical Fibre | Carbon fiber, |
| | Products, UK | basis wt. 10 g/m² |
| TFP Copolyester | Technical Fibre | Carbon fiber, |
| (black) | Products, UK | basis wt. 10 g/m² |
| CEREX ™ 23030 | Cerex Advanced | nylon fiber, |
| | Fabrics, | basis wt. 10 g/m² |
| | Pensacola, FL | |
| CEREX ™ 21030 | Cerex Advanced | nylon fiber, |
| Trilobal | Fabrics, | basis wt. 10 g/m² |
| | Pensacola, FL | |
| PBN-II ™ 3003 | Cerex Advanced | nylon fiber, |
| | Fabrics, | basis wt. 10 g/m² |
| | Pensacola, FL | |

### Example 1

Testing of Fiber Reinforcements

Table 2 below provides a summary of various test data for fiber reinforcements used in the present invention.

TABLE 2
Test Data For Fiber Reinforcements

| | | UV | | Basis | Avg. Bulk |
|---|---|---|---|---|---|
| | Air Perm. | Light | Fiber | Wt. | Thickness |
| Fiber | cfm/ft² | Perm. | Diameter | oz/yd² | mils |
| Reinforcement | (m³/m²/sec) | (%) | (μ) | (g/m²) | (mm) |
| REEMAY ™ | 1307 | 80 | 16 | 0.5 | 5 |
| 2250 | (6.63) | | | (17) | (0.13) |
| REEMAY ™ | 868⁽¹⁾ | NT | 16 | 0.75 | 6 |
| 2275 | (4.40) | | | (25.7) | (0.15) |
| TFP | NA | 95 | 12 | 0.23 | NA |
| 20202A/8 | | | | (8) | |
| TFP | NA | 92 | 12 | 0.35 | NA |
| 20202A/12 | | | | (12) | |
| TFP | NA | 84 | 12 | 0.50 | NA |
| 20202A/17 | | | | (17) | |
| TFP | NA | 76 | 12 | 0.73 | NA |
| 20204A | | | | (25) | |
| TFP | NA | NT | 12 | 0.79 | NA |
| 20216 | | | | (27) | |
| TFP | NA | 76.5 | 6.5 | 0.23 | NA |
| A1-7-2 | | | | (8) | |
| TFP | NA | 77 | 6.5 | 0.35 | NA |
| Microdenier | | | | (12) | |
| TFP | NA | NT | 6.5 | 0.73 | NA |
| A1-2-10 | | | | (25) | |
| TFP | NA | NT | 10 | 0.23 | NA |
| 20404A | | | | (8) | |
| TFP | NA | NT | 12 | 0.38 | NA |
| 206012A | | | | (13) | |
| TFP | NA | NT | 10 | 0.16 | NA |
| 20103A/5.5 | | | | (5.5) | |
| TFP | NA | NT | 10 | 0.3 | NA |
| 20103A/10 | | | | (10) | |
| TFP | NA | NT | 10 | 0.5 | NA |
| 20103A/17 | | | | (17) | |
| TFP | NA | NT | 10 | 0.9 | NA |
| 20103A/30 | | | | (30) | |
| TFP | NA | NT | NA | 0.5 | NA |
| 20107A | | | | (17) | |
| TFP | NA | NT | 6.8 | 0.75 | NA |
| 20301 | | | | (25.7) | |
| TFP | NA | 43 | 6.8 | 0.23 | NA |
| Copolyester | | | | (8) | |
| (black) | | | | | |
| CEREX ™ | 1330 | 97 | NA | 0.35 | 2.7⁽²⁾ |
| 23030 | (6.8) | | | (12) | (0.07) |
| CEREX ™ | 1283 | 91 | NA | 0.50 | 3.0⁽²⁾ |
| 21030 | (6.5) | | | (17) | (0.08) |
| PBN-II ™ | 1380 | 93 | NA | 0.73 | 3.9⁽²⁾ |
| 3003 | (7.0) | | | (25) | (0.10) |

⁽¹⁾as measured by Frazier Air Permeability, cfm/ft² at 0.5 in. water.
⁽²⁾as measured by ASTM D-1777-64
NA = not available from manufacturer
NT = not tested

### Example 2

Preparation of Structural Adhesive Layer Compositions

A number of structural adhesive layer compositions were prepared using the components as shown in Table 1 above. The following procedure was followed to prepare all of the compositions.

The liquid epoxy, hydroxyl-containing material, and phenoxy resin components, when present, were pre-mixed in a glass jar at a temperature of about 90° C. The thermoplastic and solid epoxy components were combined in a Brabender PLASTICORDER™ mixer (Model No. PL2000, available from C.W. Brabender Instruments, Inc., South Hackensack, N.J.) and mixed at a temperature of up to 105° C. The mix temperature was 80° C. for the polyester-containing compositions, 90° C. for the EVA-containing compositions, and 105° C. for the (meth)acrylate-containing compositions. The mixtures were blended until homogeneous (about 20 minutes).

The liquid pre-mix was then poured into the Brabender PLASTICORDER™ mixer to combine the liquid components with the formerly solid components. The entire mixture was allowed to blend until fully homogeneous, about 10 minutes. Any filler was then added to the mixture. Lastly, the photoinitiator was added to the mixture, and mixing was continued for about 5 more minutes.

The resulting mixture was then collected and placed between two siliconized paper liners, which had been previously threaded into a heated knife coater. The knife coater had a bed and knife temperature of about 90° C., and a heated radiator on top of the bed at about 175° C. Hot knife coating resulted in an adhesive sheet having a thickness of about 250 microns (10 mil.) between the paper release liners.

The following polyester-containing adhesive compositions shown in Table 3 were prepared.

TABLE 3
Polyester-containing Adhesive Compositions

Formulation (Amount in wt. %)

| Ingredients | PE-1 | PE-2 | PE-3 | PE-4 |
|---|---|---|---|---|
| DYNAPOL ™ | 30 | 40 | 30 | 32.7 |
| S1422 | | | | |
| PAPHEN ™ | 10 | 8.6 | 10 | 0 |
| PKHP-200 | | | | |
| EPON ™ TM 828 | 27 | 23.1 | 27 | 0 |
| EPON ™ 1001F | 22 | 18.7 | 22 | 26.7 |
| VORANOL ™ | 10 | 8.6 | 0 | 9.9 |
| 230-238 | | | | |
| UVI-6974 | 1 | 1 | 1 | 1 |
| Polycaprolactone | 0 | 0 | 10 | 0 |
| Triol | | | | |
| D.E.N. 438 | 0 | 0 | 0 | 29.7 |

The following EVA-containing adhesive compositions shown in Table 4 were prepared.

TABLE 4
EVA-containing Adhesive Compositions

Formulations (Amount in wt. %)

| Ingredients | EE-1 | EE-2 | EE-3 | EE-4 |
|---|---|---|---|---|
| LEVAPREN ™ | 30 | 30 | 30 | 27 |
| 700HV | | | | |
| PAPHEN ™ | 10 | 14.7 | 10 | 9 |
| PKHP-200 | | | | |
| EPON ™ 828 | 27 | 39.6 | 27 | 24.2 |
| EPON ™ 1001F | 22 | 0 | 0 | 19.8 |
| EPON ™ 1004 | 0 | 0 | 22 | 0 |
| VORANOL ™ | 10 | 14.7 | 0 | 9 |
| 230-238 | | | | |
| UVI-6974 | 1 | 1 | 1 | 1 |
| ZEON ™ F-351 | 0 | 0 | 0 | 10 |

The following (meth)acrylate-containing adhesive compositions shown in Table 5 were prepared.

TABLE 5
(Meth)acrylate-containing Adhesive Compositions

| | AE-1 |
|---|---|
| Ingredients | Amount in wt. % |
| HYTEMP ™ 4051EP | 30 |
| EPON ™ 828 | 53.9 |
| EPON ™ 1001F | 9.8 |
| VORANOL ™ 230-238 | 43 |
| UVI-6974 | 2 |

### Example 3

Incorporation of Fiber Reinforcements into the Structural Adhesive Layer Compositions

A number of structural adhesive layers were prepared using the fiber reinforcements of Table 1 and the adhesive compositions prepared in Example 2. The following procedure was followed to prepare all of the structural adhesive layers.

One siliconized paper release liner was removed from the uncured adhesive composition sheet prepared above in Example 2. A fiber reinforcement was placed on the exposed surface of the uncured adhesive sheet. The siliconized paper release liner was placed on the upper surface of the fiber reinforcement, and the assembly was then passed through a vacuum hot laminator (SCOTCHLITE™ Vacuum Applicator, manufactured by 3M Company, St. Paul, Minn.) at a laminating temperature of about 150° F. (about 65.6° C.) and hot pressed for up to 10 minutes. Alternatively, the assembly was then passed through the vacuum hot laminator at room temperature (about 23° C.) and pressed for up to 10 minutes until the fiber reinforcement was fully submerged into the adhesive sheet. The length of press time varied depending on the air permeability of the fiber reinforcement and the flowability of the adhesive composition. The resulting structural adhesive layer had an overall thickness of about 250 microns (10 mil).

A variety of structural adhesive layer samples were prepared using the method described above. A description of samples is given below in Table 6.

TABLE 6
Structural Adhesive Layer Samples

| Sample No. | Adhesive Sheet | Fiber Reinforcement |
|---|---|---|
| 1 | PE-1 | REEMAY ™ 2250 |
| 2 | PE-1 | REEMAY ™ 2275 |
| 3 | PE-1 | TFP 20202A/8 |
| 4 | PE-1 | TFP 20202A/12 |
| 5 | PE-1 | TFP 20202A/17 |
| 6 | PE-1 | TFP 20204A |
| 7 | PE-1 | TFP 20216 |
| 8 | PE-1 | TFP A1-7-2 |
| 9 | PE-1 | TFP A1-2-10 |
| 10 | PE-1 | TFP 20404A |
| 11 | PE-1 | TFP 20601A |
| 12 | PE-1 | TFP 20103A/5.5 |
| 13 | PE-1 | TFP 20103A/10 |
| 14 | PE-1 | TFP 20103A/17 |
| 15 | PE-1 | TFP 20103A/30 |
| 16 | PE-1 | TFP 20107A |
| 17 | PE-1 | TFP 20301 |
| 18 | PE-2 | REEMAY ™ 2250 |
| 19 | PE-3 | REEMAY ™ 2250 |
| 20 | PE-4 | REEMAY ™ 2250 |
| 21 | EE-1 | REEMAY ™ 2250 |
| 22 | EE-2 | REEMAY ™ 2250 |
| 23 | EE-3 | REEMAY ™ 2250 |
| Comparative C-1 | PE-1 | None |
| Comparative C-2 | PE-2 | None |
| Comparative C-3 | PE-3 | None |
| Comparative C-4 | PE-4 | None |
| Comparative C-5 | EE-1 | None |
| Comparative C-6 | EE-2 | None |
| Comparative C-7 | EE-3 | None |

### Example 4

Cold Flow and 90° Peel Testing of Uncured Structural Adhesive Layer Samples

Thee structural adhesive layer samples of Example 3 were subjected to the Cold Flow and 90° Peel tests as described above in the “Test Method” section. The results are given in Table 7 below.

TABLE 7
Cold Flow and 90° Peel Test Results

| | Uncured Sheets | |
|---|---|---|
| Sample | Cold Flow | 90° Peel |

| No. | % Flow | % Change | piw (N/mm) | % Change |
|---|---|---|---|---|
| C1 | 121 | — | 12 (2.10) | — |
| 1 | 95 | −21 | 9.6 (1.68) | −20 |
| 2 | 78 | −36 | 8 (1.40) | −33 |
| 3 | NT | — | 5.8 (1.02) | −52 |
| 4 | 89 | −26 | 7.5 (1.31) | −38 |
| 5 | NT | — | 7 (1.22) | −42 |
| 6 | NT | — | 6.1 (1.07) | −49 |
| 7 | NT | — | NT | — |
| 8 | NT | — | 8.8 (1.54) | −27 |
| 9 | NT | — | 5.8 (1.02) | −52 |
| 10 | 0 | −100 | 9.1 (1.59) | −24 |
| 11 | NT | — | 5.9 (1.03) | −51 |
| 12 | NT | — | 6.1 (1.07) | −49 |
| 13 | NT | — | 5.9 (1.03) | −51 |
| 14 | NT | — | NT | — |
| 15 | NT | — | NT | — |
| 16 | NT | — | 6.8 (1.19) | −43 |
| 17 | NT | — | 6.9 (1.21) | −43 |
| C2 | 67 | — | NT | — |
| 18 | 36 | −46 | 7.1 (1.24) | — |
| C3 | 113 | — | NT | — |
| 19 | 67 | −41 | NT | — |
| C4 | 138 | — | 6 (1.05) | — |
| 20 | 67 | −51 | 8.5 (1.49) | +42 |
| C5 | 13 | — | 13 (2.28) | −38 |
| 21 | 9 | −31 | 8 (1.40) | — |
| C6 | 46 | — | NT | — |
| 22 | 27 | −41 | 3.8 (0.66) | — |
| C7 | 9 | — | 6 (1.05) | — |
| 23 | 0 | −100 | NT | — |

### Example 5

Overlap Shear at 23° C. and Impact at 23° C. Testing of Cured Structural Adhesive Layer Samples

The structural adhesive layer samples of Example 3 were activated with UV light from a Fusion UV Curing System HP6B-6 (Fusion UV Systems, Inc., Gaithersburg, Md.) equipped with a D-bulb and then used to prepare bonded assemblies as described in the “Test Method” section. After UV activation and subsequent curing of the structural adhesive layers at ambient temperature, Overlap Shear at 23° C. and Impact at 23° C. tests were carried out on the bonded assemblies. The results are summarized in Table 8 below.

TABLE 8
Overlap Shear at 23° C. and Impact at 23° C. Test Results

| | Cured Sheets | | | | | |
|---|---|---|---|---|---|---|
| | | | Overlap Shear | | | |
| | UV Dose | | at 23° C | | Impact at 23° C. | |
| Sample | | % | psi | % | ft-lbf/in² | % |
| No. | J/cm² | Change | (MPa) | Change | (kJ/m²) | Change |
| C1 | 1.35 | — | 2200 | — | 2.37 | — |
| | | | (15.17) | | (4.98) | |
| 1 | 1.35 | 0 | 2387 | +9 | 2.04 | −14 |
| | | | (16.46) | | (4.29) | |
| 2 | 1.35 | 0 | 1798 | −18 | 2.41 | +2 |
| | | | (12.40) | | (5.06) | |
| 3 | 1.35 | 0 | 2993 | +36 | 2.73 | +15 |
| | | | (20.67) | | (5.74) | |
| 4 | 1.35 | 0 | 2627 | +19 | 3.17 | +34 |
| | | | (18.11) | | (6.66) | |
| 5 | 1.35 | 0 | 2783 | +27 | 2.91 | +23 |
| | | | (19.12) | | (6.12) | |
| 6 | 1.35 | 0 | 2551 | +16 | 2.28 | −4 |
| | | | (17.59) | | (4.79) | |
| 7 | 1.35 | 0 | 2883 | +31 | 2.62 | +11 |
| | | | (19.88) | | (5.51) | |
| 8 | 1.35 | 0 | 2788 | +27 | 3.20 | +35 |
| | | | (19.22) | | (6.72) | |
| 9 | 1.35 | 0 | 2591 | +18 | 1.72 | −27 |
| | | | (17.86) | | (3.61) | |
| 10 | 1.35 | 0 | 2984 | +36 | 2.53 | +7 |
| | | | (20.57) | | (5.32) | |
| 11 | 1.35 | 0 | 2411 | +10 | 1.75 | −26 |
| | | | (16.62) | | (3.68) | |
| 12 | 1.35 | 0 | 2782 | +26 | 2.42 | +2 |
| | | | (19.18) | | (5.09) | |
| 13 | 1.35 | 0 | 3038 | +38 | 2.51 | +6 |
| | | | (20.95) | | (5.27) | |
| 14 | 1.35 | 0 | 2999 | +36 | 2.54 | +7 |
| | | | (20.68) | | (5.34) | |
| 15 | 1.35 | 0 | 2834 | +29 | 2.58 | +9 |
| | | | (19.54) | | (5.42) | |
| 16 | 1.35 | 0 | 2963 | +35 | 2.49 | +5 |
| | | | (20.43) | | (5.23) | |
| 17 | 1.35 | 0 | 2815 | +28 | 1.84 | −22 |
| | | | (19.41) | | (3.87) | |
| C2 | 1.35 | — | 2658 | — | — | — |
| | | | (18.33) | | | |
| 18 | 1.8 | 33 | 1705 | −36 | 1.63 | −31 |
| | | | (11.76) | | (3.43) | |
| C3 | 0.9 | — | 1809 | — | 0.38 | — |
| | | | (12.47) | | (0.80) | |
| 19 | 0.9 | 0 | 915 | −49 | 0.33 | −13 |
| | | | (6.31) | | (0.69) | |
| C4 | 0.9 | — | 2326 | — | 0.81 | — |
| | | | (16.04) | | (1.70) | |
| 20 | 0.9 | 0 | 2259 | −3 | 1.33 | +64 |
| | | | (15.58) | | (2.79) | |
| C5 | 1.8 | — | 1795 | — | 2.69 | — |
| | | | (12.38) | | (5.65) | |
| 21 | 1.8 | 0 | 1274 | −29 | 1.48 | −45 |
| | | | (8.78) | | (3.11) | |
| C6 | 1.35 | — | 2113 | — | 2.72 | — |
| | | | (14.54) | | (5.72) | |
| 22 | 1.35 | 0 | 1354 | −36 | 2.51 | −8 |
| | | | (9.34) | | (5.27) | |
| C7 | 1.8 | — | 1244 | — | 1.8 | — |
| | | | (8.51) | | (3.78) | |
| 23 | 1.8 | 0 | 843 | −32 | 1.45 | −19 |
| | | | (5.81) | | (3.05) | |

One of the early issues with adding a fiber reinforcement to an adhesive composition was to determine whether or not the addition of a fiber reinforcement would inhibit curing of the adhesive by UV light exposure. As shown in Table 8, with only a single exception, the addition of a fiber reinforcement did not increase the UV dose requirement to fully cure the structural adhesive layer.

An unexpected strength increase was observed in overlap shear and impact strength at room temperature for some of the samples. In a number of samples, such as samples 3-5 and 7-8, the addition of a fiber reinforcement significantly increased the bond strength and resulted in a favorable shift in failure mode from adhesive failure to cohesive failure.

### Example 6

Additional Structural Adhesive Layer Compositions

Additional structural adhesive layers were prepared using the fiber reinforcements of Table 1, the adhesive compositions prepared in Example 2, and the method outlined in Example 3. A description of the additional structural adhesive layers is given below in Table 9.

TABLE 9
Additional Structural Adhesive Layers

| Sample No. | Adhesive Sheet | Fiber Reinforcement |
|---|---|---|
| Comparative C1 | PE-1 | None |
| 24 | PE-1 | REEMAY ™ 2250 |
| 25 | PE-1 | TFP A1-7-2 |
| 26 | PE-1 | TFP Copolyester |
| | | (black) |
| 27 | PE-1 | CEREX ™ 23030 |
| 28 | PE-1 | CEREX ™ 21030 |
| | | Trilobal |
| Comparative C5 | EE-1 | None |
| 29 | EE-1 | REEMAY ™ 2250 |
| 30 | EE-1 | TFP A1-7-2 |
| 31 | EE- 1 | TFP Copolyester |
| (black) | | |
| 32 | EE-1 | CEREX ™ 23030 |
| 33 | EE-1 | CEREX ™ 21030 |
| | | Trilobal |
| Comparative C6 | EE-4 | None |
| 34 | AE-1 | REEMAY ™ 2250 |
| 35 | AE-1 | TFP A1-7-2 |
| 36 | AE-1 | TFP Copolyester |
| | | (black) |
| 37 | PE-1 | PBN-II ™ 3003 |
| 38 | EE-1 | PBN-II ™ 3003 |

### Example 7

Overlap Shear at 23° C. and 65° C., Impact at 23° C. and −20° C., and Floating Roller Peel Testing of Cured Structural Adhesive Layer

### Samples

The structural adhesive layer samples of Example 6 were activated with UV light and then used to prepare bonded assemblies as described in the “Test Method” section.

After UV activation and subsequent curing of the structural adhesive layers at ambient temperature, Overlap Shear at 23° C. and 65° C., Impact at 23° C. and −20° C., and Floating Roller Peel tests were carried out on the bonded assemblies as described in the “Test Method” section. The results are summarized in Table 10 below.

TABLE 10
Overlap Shear at 23° C. and 65° C., Impact at 23° C. and −20° C.,
and Floating Roller Peel Test Results

| | | Impact | | | | | |
|---|---|---|---|---|---|---|---|
| | | ft-lbf/in² | | | | | |
| | | (kJ/m²) | | | | | |
| | | Cured | Cured | Cured | Overlap Shear | | Floating |
| | | at | at | at | psi | | Roller |
| Sam- | UV | 23° C., | 23° C., | 85° C., | (MPa) | | Peel, |
| ple | Dose, | tested at | tested at | tested at | at | at | piw |
| No. | J/cm² | −20° C. | 23° C. | 23° C. | 23° C. | 65° C. | (N/mm) |
| C1 | 1.35 | 0.181 | 0.455 | 2.37 | 2200 | 625 | 3.4 |
| | | (0.380) | (0.956) | (4.98) | (15.17) | (4.31) | (0.595) |
| 24 | 1.35 | 0.162 | 0.187 | 2.04 | 2387 | 368 | 3.8 |
| | | (0340) | (0.393) | (4.29) | (16.46) | (2.54) | (0.66) |
| 25 | 1.35 | 0.174 | 0.231 | 3.20 | 2788 | 431 | 6.9 |
| | | (0.366) | (0.485) | (6.72) | (19.22) | (2.97) | (1.21) |
| 26 | 1.35 | 0.143 | 0.180 | 1.57 | 1123 | 406 | 6.3 |
| | | (0.301) | (0.378) | (3.29) | (7.74) | (2.80) | (1.10) |
| 27 | 1.35 | 0.548 | 0.670 | 2.10 | 1262 | 1104 | 14.1 |
| | | (1.15) | (1.41) | (4.41) | (8.70) | (7.61) | (2.47) |
| 28 | 1.35 | 0.996 | 0.688 | 2.50 | 1427 | 875 | 13.1 |
| | | (2.09) | (1.44) | (5.25) | (9.84) | (6.03) | (2.29) |
| 37 | 1.35 | 0.823 | 0.294 | 1.99 | 1130 | 723 | 56.8 |
| | | (1.73) | (0.618) | (4.18) | (7.79) | (4.98) | (9.95) |
| C5 | 1.80 | 1.134 | 1.081 | 2.69 | 1795 | 521 | 16.5 |
| | | (2.38) | (2.27) | (5.65) | (12.38) | (3.59) | (2.89) |
| 29 | 1.80 | 0.460 | 1.085 | 2.02 | 1274 | 366 | 9.3 |
| | | (0.967) | (2.28) | (4.25) | (8.78) | (2.52) | (1.63) |
| 30 | 1.80 | 0.427 | 1.074 | 1.48 | 1688 | 451 | 20.7 |
| | | (0.897) | (2.26) | (3.11) | (11.64) | (3.11) | (3.625) |
| 31 | 2.25 | 0.212 | 0.938 | 2.12 | 1817 | 377 | 7.4 |
| | | (0.446) | (1.97) | (4.45) | (12.53) | (2.60) | (1.30) |
| 32 | 1.80 | 0.712 | 1.326 | 2.06 | 1491 | 717 | 14.9 |
| | | (1.496) | (2.79) | (4.32) | (10.28) | (4.94) | (2.61) |
| 33 | 1.80 | 1.248 | 1.387 | 1.54 | 1575 | 772 | 15.9 |
| | | (2.62) | (2.91) | (3.24) | (10.86) | (5.32) | (2.78) |
| 38 | 1.80 | 0.388 | 1.464 | 1.91 | 1575 | 723 | 32.7 |
| | | (0.815) | (3.08) | (4.02) | (10.86) | (4.98) | (5.73) |
| C6 | 1.80 | 0.446 | 0.483 | NT | NT | 374 | 8.4 |
| | | (0.937) | (1.02) | | | (2.58) | (1.47) |
| 34 | 3.15 | 0.143 | 1.027 | NT | NT | 312 | 11.6 |
| | | (0.301) | (2.16) | | | (2.15) | (2.03) |
| 35 | 3.15 | 0.156 | 1.171 | NT | NT | 290 | 7.2 |
| | | (0.328) | (2.46) | | | (2.00) | (1.26) |
| 36 | 3.60 | 0.149 | 1.222 | NT | NT | 133 | 3.9 |
| | | (0.313) | (2.57) | | | (0.92) | (0.68) |

NT = not tested

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A structural adhesive layer activatable upon exposure to actinic radiation, said structural adhesive layer comprising:
(a) a layer of adhesive material, wherein the adhesive material is a mixture of:
(i) about 20 to about 80 weight percent of one or more epoxy resins;
(ii) about 20 to about 50 weight percent of one or more resins selected from polyester resins, ethyl vinyl acetate resins, and acrylate resins;
(iii) up to about 30 weight percent of one or more hydroxy-containing compounds;
(iv) up to about 5 weight percent of one or more photoinitiators; and
(v) up to about 50 weight percent of one or more additives; wherein all weight percentages are based on a total weight of the mixture; and
(b) at least one web of fibers at least partially embedded within the layer of adhesive material, wherein the at least one web of fibers has a basis weight of less than about 30 grams per squaremeter, an air permeability value of more than about 600 cfm/ft² (3.04 m³/m²/sec) as measured by ASTM D737-75 or ASTM D737-80, a light permeability value of more than about 10% as measured by Light Permeability Test LPT, and comprises fibers having an average fiber diameter of less than about 20 microns.

2. The structural adhesive layer of claim 1, wherein the layer of adhesive material comprises a mixture of:
(i) about 30 to about 60 weight percent of one or more epoxy resins;
(ii) about 30 to about 40 weight percent of one or more resins selected from polyester resins, ethyl vinyl acetate resins, and (meth)acrylate resins;
(iii) about 9 to about 20 weight percent of one or more hydroxy-containing compounds;
(iv) up to about 2 weight percent of one or more photoinitiators; and
(v) up to about 10 weight percent of one or more additives; wherein all weight percentages are based on the total weight of the mixture.

3. The structural adhesive layer of claim 2, wherein the layer of adhesive material comprises a mixture of:
(i) about 30 to about 60 weight percent of one or more epoxy resins;
(ii) about 30 to about 40 weight percent of polyester resin;
(iii) about 9 to about 20 weight percent of one or more hydroxy-containing compounds; and
(iv) up to about 1 weight percent of one or more photoinitiators; wherein all weight percentages are based on the total weight of the mixture.

4. The structural adhesive of claim 3, wherein the layer of adhesive material comprises a mixture of:
(i) about 27 weight percent of a first epoxy resin having an epoxy equivalent weight of about 185 to about 192, and about 22 weight percent of a second epoxy resin having an epoxy equivalent weight of about 525 to about 550;
(ii) about 30 weight percent of a polyester resin, wherein the polyester resin is an amorphous branched copolyester having a glass transition temperature of less than about −5° C.;
(iii) about 10 weight percent of a first hydroxy-containing compound comprising a micronized phenoxy resin having a number average molecular weight of from about 10,000 to about 16,000 and a hydroxy equivalent weight of about 284, and about 10 weight percent of a second hydroxy-containing compound comprising a polyol adduct of glycol and propylene oxide having a number average molecular weight of about 700 and a hydroxy equivalent weight of about 38; and
(iv) about 1 weight percent of one or more photoinitiators; wherein all weight percentages are based on the total weight of the mixture.

5. The structural adhesive layer of claim 4, wherein the at least one web of fibers has a basis weight of less than about 25 grams per square meter, an air permeability value of more than about 800 cfm/ft² (4.06 m³/m²/sec) as measured by ASTM D737-75 or ASTM D737-80, a light permeability value of more than about 75% as measured by Light Permeability Test LPT, and comprises polyester fibers having an average fiber diameter of less than about 7 microns.

6. The structural adhesive layer of claim 1, wherein the layer of adhesive material comprises a mixture of.
(i) about 30 to about 60 weight percent of one or more epoxy resins;
(ii) about 30 to about 40 weight percent of one or more ethyl vinyl acetate resins;
(iii) about 9 to about 20 weight percent of one or more hydroxy-containing compounds;
(iv) up to about 2 weight percent of one or more photoinitiators; and
(v) up to about 10 weight percent of one or more additives; wherein all weight percentages are based on the total weight of the mixture.

7. The structural adhesive layer of claim 6, wherein the layer of adhesive material comprises a mixture of:
(i) about 27 weight percent of a first epoxy resin having an epoxy equivalent weight of about 185 to about 192, and about 22 weight percent of a second epoxy resin having an epoxy equivalent weight of about 525 to about 550;
(ii) about 30 weight percent of an ethyl vinyl acetate resin, wherein the ethyl vinyl acetate resin comprises about 70 weight percent vinyl acetate;
(iii) about 10 weight percent of a first hydroxy-containing compound comprising a micronized phenoxy resin having a number average molecular weight of from about 10,000 to about 16,000 and a hydroxy equivalent weight of about 284, and about 10 weight percent of a second hydroxy-containing compound comprising a polyol adduct of glycol and propylene oxide having a number average molecular weight of about 700 and a hydroxy equivalent weight of about 38; and
(v) about 1 weight percent of one or more photoinitiators; wherein all weight percentages are based on the total weight of the mixture.

8. The structural adhesive layer claim 7, wherein the at least one web of fibers has a basis weight of less than about 10 grams per square meter, an air permeability value of more than about 1200 cfm/ft² (6.09 m³/m²/sec) as measured by ASTM D737-75 or ASTM D737-80, a light permeability value of more than about 90% as measured by Light Permeability Test LPT, and comprises nylon fibers having a trilobal cross-sectional shape and an average fiber diameter of less than about 20 microns.

9. The structural adhesive layer of claim 1, wherein the layer of adhesive material comprises a mixture of:
(i) about 20 to about 80 weight percent of one or more epoxy resins;
(ii) about 30 to about 40 weight percent of one or more acrylate resins;
(iii) about 9 to about 20 weight percent of one or more hydroxy-containing compounds;
(iv) up to about 3 weight percent of one or more photoinitiators; and
(v) up to about 10 weight percent of one or more additives; wherein all weight percentages are based on the total weight of the mixture.

10. The structural adhesive layer of claim 9, wherein the layer of adhesive material comprises a mixture of:
(i) about 53.9 weight percent of a first epoxy resin having an epoxy equivalent weight of about 185 to about 192, and about 9.8 weight percent of a second epoxy resin having an epoxy equivalent weight of about 525 to about 550;
(ii) about 30 weight percent of a (meth)acrylate resin, wherein the (meth)acrylate resin comprises a poly(meth)acrylate elastomer having an ethylene, propylene or butylene repeating unit, wherein the ethylene, propylene or butylene repeating unit molar ratio to (meth)acrylate repeating units is less than about 2;
(iii) about 4.3 weight percent of a hydroxy-containing compound comprising a polyol adduct of glycol and propylene oxide having a number average molecular weight of about 700 and a hydroxy equivalent weight of about 38; and
(iv) about 2 weight percent of one or more photoinitiators; wherein all weight percentages are based on the total weight of the mixture.

11. The structural adhesive layer of claim 10, wherein the at least one web of fibers has a basis weight of less than about 25 grams per square meter, an air permeability value of more than about 1300 cfm/ft² (6.59 m³/m²/sec) as measured by ASTM D737-75 or ASTM D737-80, a light permeability value of more than about 75% as measured by Light Permeability Test LPT, and comprises polyester fibers having a round cross-sectional shape and an average fiber diameter of less than about 20 microns.

12. A structural bonding tape comprising the structural adhesive layer of claim 1.

13. The structural bonding tape of claim 12, wherein the tape further comprises at least one additional layer.

14. The structural bonding tape of claim 13, wherein the at least one additional layer comprises a release liner, a non-structural adhesive layer, a non-adhesive film, a foil, a paper, a foam, a woven fabric, a nonwoven fabric, a knitted fabric, or a combination thereof.

15. A roll of tape comprising the structural bonding tape of claim 12.

16. A cured sheet of adhesive comprising the structural adhesive layer of claim 1.

17. A method of making a structural adhesive layer which is activatable upon exposure to actinic radiation, said method comprising:
forming a mixture comprising:
(i) about 20 to about 80 weight percent of one or more epoxy resins;
(ii) about 20 to about 50 weight percent of one or more resins selected from polyester resins, ethyl vinyl acetate resins, and (meth)acrylate resins;
(iii) up to about 30 weight percent of one or more hydroxy-containing compounds;
(iv) up to about 5 weight percent of one or more photoinitiators; and
(v) up to about 50 weight percent of one or more additives; wherein all weight percentages are based on a total weight of the mixture;
applying a sheet of the mixture to a substrate;
contacting the sheet with at least one web of fibers so that the at least one web of fibers is at least partially embedded in the sheet, wherein the at least one web of fibers has a basis weight of less than about 30 grams per square meter, an air permeability value of more than about 600 cfm/ft² (3.04 m³/m²/sec) as measured by ASTM D737-75 or ASTM D737-80, a light permeability value of more than about 10% as measured by Light Permeability Test LPT, and comprises fibers having an average fiber diameter of less than about 20 microns.

18. The method of claim 17, wherein the method further comprises:
positioning at least one additional layer on an exposed surface of the structural adhesive layer, wherein the at least one additional layer comprises a release liner, a non-structural adhesive layer, a non-adhesive film, a foil, a paper, a foam, a woven fabric, a nonwoven fabric, a knitted fabric, or a combination thereof.

19. A bonded article comprising:
a first substrate;
a second substrate; and
a structural adhesive layer positioned between the first substrate and the second substrate, wherein the structural adhesive layer comprises:
(a) a layer of adhesive material, wherein the adhesive material is a mixture of:
(i) about 20 to about 80 weight percent of one or more epoxy resins;
(ii) about 20 to about 50 weight percent of one or more resins selected from polyester resins, ethyl vinyl acetate resins, and (meth)acrylate resins;
(iii) up to about 30 weight percent of one or more hydroxy-containing compounds;
(iv) up to about 5 weight percent of one or more photoinitiators; and
(v) up to about 50 weight percent of one or more additives; wherein all weight percentages are based on a total weight of the mixture; and
(b) at least one web of fibers at least partially embedded within the layer of adhesive material, wherein the at least one web of fibers has a basis weight of less than about 30 grams per square meter, an air permeability value of more than about 600 cfm/ft² (3.04 m³/m²/sec) as measured by ASTM D737-75 or ASTM D737-80, a light permeability value of more than about 10% as measured by Light Permeability Test LPT, and comprises fibers having an average fiber diameter of less than about 20 microns;
wherein the structural adhesive layer is activatable upon exposure to actinic radiation and fully curable without heat.

20. The bonded article of claim 19, wherein the layer of adhesive material comprises a mixture of:
(i) about 27 weight percent of a first epoxy resin having an epoxy equivalent weight of about 185 to about 192, and about 22 weight percent of a second epoxy resin having an epoxy equivalent weight of about 525 to about 550;
(ii) about 30 weight percent of a polyester resin, wherein the polyester resin is an amorphous branched copolyester having a glass transition temperature of less than about −5° C.;
(iii) about 10 weight percent of a first hydroxy-containing compound comprising a micronized phenoxy resin having a number average molecular weight of from about 10,000 to about 16,000 and a hydroxy equivalent weight of about 284, and about 10 weight percent of a second hydroxy-containing compound comprising a polyol adduct of glycol and propylene oxide having a number average molecular weight of about 700 and a hydroxy equivalent weight of about 38; wherein all weight percentages are based on the total weight of the mixture; and
(iv) about 1 weight percent of one or more photoinitiators; wherein all weight percentages are based on the total weight of the mixture; and
wherein the at least one web of fibers has a basis weight of less than about 25 grams per square meter, an air permeability value of more than about 800 cfm/ft² (4.06 m³/m²/sec) as measured by ASTM D737-75 or ASTM D737-80, a light permeability value of more than about 75% as measured by Light Permeability Test LPT, and comprises polyester fibers having an average fiber diameter of less than about 7 microns.

21. The bonded article of claim 19, wherein the layer of adhesive material comprises a mixture of:
(i) about 27 weight percent of a first epoxy resin having an epoxy equivalent weight of about 185 to about 192, and about 22 weight percent of a second epoxy resin having an epoxy equivalent weight of about 525 to about 550;
(ii) about 30 weight percent of an ethyl vinyl acetate resin, wherein the ethyl vinyl acetate resin comprises about 70 weight percent vinyl acetate;
(iii) about 10 weight percent of a first hydroxy-containing compound comprising a micronized phenoxy resin having a number average molecular weight of from about 10,000 to about 16,000 and a hydroxy equivalent weight of about 284, and about 10 weight percent of a second hydroxy-containing compound comprising a polyol adduct of glycol and propylene oxide having a number average molecular weight of about 700 and a hydroxy equivalent weight of about 38; and
(iv) about 1 weight percent of one or more photoinitiators; wherein all weight percentages are based on the total weight of the mixture; and
wherein the at least one web of fibers has a basis weight of less than about 10 grams per square meter, an air permeability value of more than about 1200 cfm/ft² (6.09 m³/m²/sec) as measured by ASTM D737-75 or ASTM D737-80, a light permeability value of more than about 90% as measured by Light Permeability Test LPT, and comprises nylon fibers having a trilobal cross-sectional shape and an average fiber diameter of less than about 20 microns.

22. The bonded article of claim 19, wherein the layer of adhesive material comprises a mixture of:
(i) about 53.9 weight percent of a first epoxy resin having an epoxy equivalent weight of about 185 to about 192, and about 9.8 weight percent of a second epoxy resin having an epoxy equivalent weight of about 525 to about 550;
(ii) about 30 weight percent of a (meth)acrylate resin, wherein the (meth)acrylate resin comprises a poly(meth)acrylate elastomer having an ethylene, propylene or butylene repeating unit, wherein the ethylene, propylene or butylene repeating unit molar ratio to (meth)acrylate repeating units is less than about 2;
(iii) about 4.3 weight percent of a hydroxy-containing compound comprising a polyol adduct of glycol and propylene oxide having a number average molecular weight of about 700 and a hydroxy equivalent weight of about 38; and
(iv) about 2 weight percent of one or more photoinitiators; wherein all weight percentages are based on the total weight of the mixture; and
wherein the at least one web of fibers has a basis weight of less than about 25 grams per square meter, an air permeability value of more than about 1300 cfm/ft² (6.59 m³/m²/sec) as measured by ASTM D737-75 or ASTM D737-80, a light permeability value of more than about 75% as measured by Light Permeability Test LPT, and comprises polyester fibers having a round cross-sectional shape and an average fiber diameter of less than about 20 microns.

23. The bonded article of claim 19, wherein the first substrate comprises plastic, metal, ceramic, glass, cellulosic, elastomeric, rubber, wood materials, or a combination thereof; the second substrate comprises plastic, metal, ceramic, glass, cellulosic, elastomeric, rubber, wood materials, or a combination thereof; and the first substrate is similar or different from the second substrate.

24. The bonded article of claim 23, wherein the first substrate is different from the second substrate.
